(19) United States
(12) Patent Application Publication
(10) Pub. No.: US 2010/0028690 A1
(43) Pub. Date: Feb. 4, 2010

(54) High-Temperature Non-Skid Coating Composition

(75) Inventors: Albert R. Parks, Stafford, VA (US); Fred J. Berry, Alexandria, VA (US); Colin F. Quarmby, Arlington, VA (US)

Correspondence Address: Law Office of John K. Pike, PLLC, 2121 Eisenhower Avenue, Suite 200, Alexandria, VA, 22314, US

(73) Assignee: Richard Parks Corrosion Technologies, Inc., Stafford, VA (US)

(21) Appl. No.: 12/398,051

(22) Filed: Mar. 4, 2009

Related U.S. Application Data
(60) Provisional application No. 61/033,533, filed on Mar. 4, 2008.

(51) Int. Cl. C09D 163/04; B05D 3/02; B32B 27/38; B32B 15/092; B65D 71/00

(52) U.S. Cl. 428/418; 523/440; 523/150; 427/386; 428/413; 206/568

(57) ABSTRACT

One embodiment relates to a coating composition, comprising a novolac epoxy resin comprising silicon carbide powder; an amine curing agent, said agent comprising at least a cycloaliphatic amine; a hydrophobic silica thixotrope agent; and an aluminum oxide powder having the following mesh retention characteristics, based on the weight of the aluminum oxide powder: about 0 wt. % size 10 mesh, ≧ about 5 wt. % size 16 mesh, ≧ about 20 wt. % size 18 mesh, ≧ about 10 wt. % size 20 mesh, and ≦ about 5 wt. % size 30 mesh. Other embodiments relate to making and using the coating composition, and coatings made from the coating composition.

This application is based on U.S. Provisional Application No. 61/033,533, filed Mar. 4, 2008, the entire contents of which are hereby incorporated by reference.

The U.S. Government has a paid-up license in this invention and the right in limited circumstances to require the patent owner to license others on reasonable terms as provided for by the terms of Contract No. N00014-07-C-0706 awarded by the Office of Naval Research.

### BACKGROUND

1. Field of the Invention

This application relates to high-temperature non-skid coating compositions, methods of making, and methods of using same.

2. Discussion of the Background

Non-skid coatings are known and used by the U.S. Navy to provide slip resistance for personnel, deck equipment and aircraft. It is important that the slip resistance be maintained throughout the coating life cycle to ensure that no hazardous working environments are created for ship's force. Typical non-skid coating life cycles range from six months to over two years. Foot traffic, mechanical abrasion, vehicle and aircraft traffic, and corrosion constantly wear away non-skid surfaces.

Conventional non-skid compositions are described in, for example, U.S. Pat. No. 4,760,103, which describes non-skid coating compositions that contain epoxy resin, amidoamine and polyamide amine resins, pigments, fillers and thickeners, solvents and aggregates; U.S. Pat. No. 4,859,522, which describes non-skid coating composition that contains a crosslinked polyvinyl urethane; U.S. Pat. No. 5,686,507, which describes non-skid coating compositions that contain curable resin, filler and aramid flakes or fibers; U.S. Pat. No. 6,779,486, which describes non-skid compositions that contain nanolaminate pigments and epoxy resin; and U.S. Pat. No. 7,037,958, which describes non-skid compositions that contain an amine curing agent, an epoxide-containing toughening agent, an epoxy resin, and a rubber toughening agent.

The use of advanced vertical launch aircraft on U.S. Navy ships has introduced a new and serious problem to the fleet, which is not addressed by conventional non-skid coatings and which is beyond the capabilities of conventional non-skid coatings. Unlike traditional aircraft, advanced vertical launch aircraft such as vertical takeoff and landing (VTOL) aircraft and short takeoff, vertical landing (STOVL) aircraft produce hot engine exhausts that are directed downward onto a ship's deck. The exhaust temperatures from VTOL and STOVL aircraft engines can easily exceed several hundred degrees. The direct impingement of hot engine exhaust onto the ship's deck causes localized heating that is beyond the capabilities of conventional epoxy or urethane based non-skid coatings.

Additional concerns raised by the use of VTOL and STOVL aircraft over non-skid coatings include the detrimental effects of cyclic heating and cooling. Under direct engine exhaust, deck temperatures quickly increase to several hundred degrees Fahrenheit and over time to nearly twice that amount. Once heated, the deck can remain hot for several hours. Heat affected areas undergo thermal-induced buckling, creep, material degradation, cracking, and loss of welded joint integrity. Different coefficients of thermal expansion of the non-skid coating and the flight deck create stresses at the coating/flight deck interface, which can result in adhesive failure at the interface. Foreign object damage (FOD) risks arise when adhesive failure occurs and the non-skid coating breaks away from the deck surface. Failed non-skid material can be ingested by jet intakes resulting in serious damage, complete engine loss, or injury to personnel. High velocity jet blast also propels failed non-skid material across the deck at high velocities creating a safety hazard for equipment and crew.

Additional wear results when high temperature, high velocity jet engine exhaust blasts dirt, debris, delaminated non-skid material, and other abrasives across the surface of intact non-skid. These erosive elements further accelerate the degradation of the coatings.

The hazards described above can greatly affect the readiness of the fleet and safety of personnel. The present inventors have recognized that conventional non-skid coating systems are inadequate to withstand the combined effects of VTOL and STOVL aircraft and are subject to premature failure as a result. There is thus an urgent need to provide the U.S. Navy with new non-skid coatings to meet the emerging needs associated with the use of VTOL and STOVL aircraft.

### BRIEF DESCRIPTION OF THE DRAWINGS

FIGS. 1-45 show exemplary and comparative test results of panels coated with one embodiment of a non-skid composition of the present invention and panels coated with a commercially available conventional non-skid coating.

FIG. 1 shows six plates from Part 1 of the Examples after impact testing (top row heat-exposed at 400° F., bottom row cured but unexposed).

FIG. 2 shows six plates from Part 1 of the Examples after striking with hammer and chisel found only minor surface chipping of coating (top row heat-exposed at 400° F., bottom row unexposed).

FIG. 3 shows Sample A plates after probing with chisel by hand (impact tested after 10 cycles thermal aging at 400° F.).

FIG. 4 shows Sample B plates after probing with chisel (impact tested after 15 days seawater immersion).

FIG. 5 shows Sample C plates after impact testing and probing with chisel (flame sprayed zirconia and epoxy non-skid coatings).

FIG. 6 shows Sample D plates after UV-B aging and humidity condensation (200 hours in QUV tester).

FIG. 7 shows Sample D2 impacted plate after 200 hours UV-B aging and humidity condensation (rusting under impact zone).

FIG. 8 shows Sample D2 after 200 hours UV-B aging and humidity condensation (coating chipped off to expose corrosion).

FIG. 9 shows Sample D2 after 200 hours UV-B aging and humidity condensation (coating chipped off chipped to expose corrosion).

FIG. 10 shows Sample D3 after 200 hours UV-B aging and humidity condensation (coating chipped off to expose corrosion).

FIG. 11 shows Sample D3 after 200 hours UV-B aging and humidity condensation (coating chipped off to expose corrosion).

FIG. 12 shows Samples E1 (left side) and E2 (right side) non-impacted and impacted plates before accelerated corrosion (1000 hours salt spray).

FIG. 13 shows Samples E3 (left side) and F1 (right side) scribed plates before 1000 hours salt spray.

FIG. 14 shows Sample E3 scribed plate after 48 hours salt spray.

FIG. 15 shows Samples E1 (left side) and E2 (right side) after 218 hours salt spray.

FIG. 16 shows close-up of Sample E1 after 218 hours salt spray.

FIG. 17 shows Samples E3 (left side) and F1 (right side) scribed plates after 218 hours salt spray.

FIG. 18 shows Samples E1 (left side) and E2 (right side) after 360 hours salt spray.

FIG. 19 shows Samples E3 (left side) and F1 (right side) scribed plates after 360 hours salt spray.

FIG. 20 shows Sample E1 after 1000 hours salt spray.

FIG. 21 shows Sample E2 after 1000 hours salt spray.

FIG. 22 shows Sample E2 after 1000 hours salt spray and removal of coating from impacts to expose corrosion.

FIG. 23 shows Sample E2 after 1000 hours salt spray; significant corrosion is visible under upper left impact.

FIG. 24 shows Sample E2 after 1000 hours salt spray; significant corrosion is visible under upper left impact.

FIG. 25 shows Sample E3 after 1000 hours salt spray.

FIG. 26 shows Sample F1 after 1000 hours salt spray.

FIG. 27 shows Sample E3 after 1000 hours salt spray and removal of coating by chipping.

FIG. 28 shows Sample E3 after 1000 hours salt spray and removal of coating by chipping.

FIG. 29 shows Sample E3 after 1000 hours salt spray and removal of coating by chipping.

FIG. 30 shows Sample F1 after 1000 hours salt spray and removal of coating by chipping.

FIG. 31 shows Sample F1 after 1000 hours salt spray and removal of coating by chipping.

FIG. 32 shows two plates with a comparative coating before impact testing (left plate cured at 70° F., right plate thermally aged at 400° F.).

FIG. 33 shows six plates with a comparative coating after impact testing (top row panels 1,2, and 3 cured at 70° F., bottom row panels 4, 5, and 6 thermally aged at 400° F.).

FIG. 34 shows thermally aged plate 4 with a comparative coating after drop impact 16.

FIG. 35 shows thermally aged plate 4 with a comparative coating after drop impact 20.

FIG. 36 shows thermally aged plate 4 with a comparative coating after drop impact 25.

FIG. 37 shows thermally aged plate 4 with a comparative coating after probing with chisel.

FIG. 38 shows thermally aged plate 5 with a comparative coating after drop impact 16.

FIG. 39 shows thermally aged plate 5 with a comparative coating after drop impact 20.

FIG. 40 shows thermally aged plate 5 with a comparative coating after drop impact 25.

FIG. 41 shows thermally aged plate 5 with a comparative coating after probing with chisel.

FIG. 42 shows thermally aged plate 6 with a comparative coating after drop impact 16.

FIG. 43 shows thermally aged plate 6 with a comparative coating after drop impact 20.

FIG. 44 shows thermally aged plate 6 with a comparative coating after drop impact 25.

FIG. 45 shows thermally aged plate 6 with a comparative coating after probing with chisel.

### DETAILED DESCRIPTION OF THE SEVERAL EMBODIMENTS

The embodiments described herein solve the above-mentioned problems, and others. One embodiment described herein provides an improved non-skid coating having high heat and impact resistance even after continuous and cyclic exposures to temperatures in excess of 400° F., slip resistance and wear resistance. This high heat and impact resistance, slip resistance and wear resistance is achieved at least in part by the use of novolac epoxies comprising silicon carbide powder and cured by a curing agent comprising at least a cycloaliphatic amine combined with a hydrophobic silica thixotrope and a distribution of aluminum oxide powder. The non-skid coating composition provides surprisingly good temperature, impact, wear, corrosion, long term slip and skid resistance and toughness.

More particularly, one embodiment described herein relates to a coating composition, comprising:

a novolac epoxy resin comprising silicon carbide powder;

an amine curing agent, said agent comprising at least a cycloaliphatic amine;

a hydrophobic silica thixotrope agent; and

an aluminum oxide powder having the following mesh retention characteristics, based on the weight of the aluminum oxide powder:
about 0 wt. % size 10 mesh,
≧ about 5 wt. % size 16 mesh,
≧ about 20 wt. % size 18 mesh,
≧ about 10 wt. % size 20 mesh, and
≦ about 5 wt. % size 30 mesh.

Another embodiment described herein relates to a coating, comprising the cured product of a coating composition, the coating composition comprising:

a novolac epoxy resin comprising silicon carbide powder;

an amine curing agent, said agent comprising at least a cycloaliphatic amine;

a hydrophobic silica thixotrope agent; and

an aluminum oxide powder having the following mesh retention characteristics, based on the weight of the aluminum oxide powder:
about 0 wt. % size 10 mesh,
≧ about 5 wt. % size 16 mesh,
≧ about 20 wt. % size 18 mesh,
≧ about 10 wt. % size 20 mesh, and
≦ about 5 wt. % size 30 mesh.

Another embodiment described herein relates to a method of coating a surface, comprising applying, to a surface, a coating composition, and allowing to cure, wherein the coating composition comprises:

a novolac epoxy resin comprising silicon carbide powder;

an amine curing agent, said agent comprising at least a cycloaliphatic amine;

a hydrophobic silica thixotrope agent; and

an aluminum oxide powder having the following mesh retention characteristics, based on the weight of the aluminum oxide powder:
about 0 wt. % size 10 mesh,
≧ about 5 wt. % size 16 mesh,
≧ about 20 wt. % size 18 mesh,
≧ about 10 wt. % size 20 mesh, and
≦ about 5 wt. % size 30 mesh.

Another embodiment described herein relates to a surface, comprising, thereon, a coating comprising the cured product of a coating composition, the coating composition comprising:

a novolac epoxy resin comprising silicon carbide powder;

an amine curing agent, said agent comprising at least a cycloaliphatic amine;

a hydrophobic silica thixotrope agent; and

an aluminum oxide powder having the following mesh retention characteristics, based on the weight of the aluminum oxide powder:
about 0 wt. % size 10 mesh,
≧ about 5 wt. % size 16 mesh,
≧ about 20 wt. % size 18 mesh,
≧ about 10 wt. % size 20 mesh, and
≦ about 5 wt. % size 30 mesh.

Another embodiment described herein relates to a kit for coating, comprising:

(a) a resin package, comprising:
a novolac epoxy resin comprising silicon carbide powder;
a hydrophobic silica thixotrope agent;
an aluminum oxide powder having the following mesh retention characteristics, based on the weight of the aluminum oxide powder:
   about 0 wt. % size 10 mesh,
   ≧ about 5 wt. % size 16 mesh,
   ≧ about 20 wt. % size 18 mesh,
   ≧ about 10 wt. % size 20 mesh, and
   ≦ about 5 wt. % size 30 mesh;

(b) a curing agent package, comprising:
an amine curing agent, said curing agent comprising at least a cycloaliphatic amine.

Another embodiment described herein relates to a method of coating a surface, comprising:

contacting the contents of a resin package (a), the resin package comprising:
a novolac epoxy resin comprising silicon carbide powder;
a hydrophobic silica thixotrope agent;
an aluminum oxide powder having the following mesh retention characteristics, based on the weight of the aluminum oxide powder:
   about 0 wt. % size 10 mesh,
   ≧ about 5 wt. % size 16 mesh,
   ≧ about 20 wt. % size 18 mesh,
   ≧ about 10 wt. % size 20 mesh, and
   ≦ about 5 wt. % size 30 mesh;

with the contents of a curing agent package (b), the curing agent package comprising:
an amine curing agent, said curing agent comprising at least a cycloaliphatic amine;

mixing; and

applying to the surface.

The present inventors recognized that there exists a need for a more durable high temperature, high impact resistant, non-skid coating to meet the emerging needs associated with the use of VTOL and STOVL aircraft, particularly aboard ships. As such, the non-skid coating described herein is particularly suitable for that application. However, the non-skid coating is not limited to such applications. It would be similarly suitable for use in other settings where a durable non-skid coating is required. Such settings include but are not limited to any decking or other suitable surface found, for example, on commercial ships, surface ships, aircraft carriers, submarines, tankers, transports, littoral ships, pleasure craft, and the like. Other suitable applications for the non-skid coating include but are not limited to the oil and gas industry, drilling or production platforms, refineries, chemical plants, manufacturing plants, warehouses, towers, storage tanks, containers, pipelines, bridges, roadways, landing areas, trucks, military vehicles, railroad cars, loading docks, walkways, taxiways, stairwells, ladders, combinations thereof, and the like.

The non-skid coating may be suitably applied to any surface on which a durable and/or high-temperature resistant non-skid surface might be desired. These include but are not limited to steel, high-carbon steel, low-carbon steel, high-yield (HY) steel, high-strength (HS) steel, high-strength, low-alloy (HSLA) steel, HSLA-100 steel, HSLA-65 steel, iron, aluminum, titanium, metal alloys, welded areas, bronze, brass, copper, concrete, asphalt, combinations thereof, and the like.

So long as it is present, the amount of novolac epoxy resin present in the composition is not particularly limited and is easily determined given the teachings herein and the knowledge of one skilled in non-skid or epoxy coatings. When determining the amount of novolac epoxy resin, one may wish to consider the coating properties, impact and heat resistance, toughness, handling and/or applicability properties, pot life, curing time, and amount of amine curing agent, for example. In one embodiment, the epoxy resin is present in an amount ranging from about 30 wt. % to about 70 wt. %, based on the weight of the epoxy resin and silicon carbide combined to the weight of the non-skid composition. This range includes any and all subranges therebetween, including for example about 30, 35, 40, 45, 50, 55, 60, 65, and 70 wt. %.

When determining the amount of novolac epoxy resin in the novolac epoxy resin/silicon carbide mixture, one may wish to consider the coating properties, handling and/or applicability properties, pot life, curing time, amount of silicon carbide powder, and amount of amine curing agent, for example. In one embodiment, the epoxy resin is present in the novolac epoxy resin/silicon carbide mixture an amount ranging from about 10 wt. % to nearly 100 wt. %, based on the weight of the epoxy resin and silicon carbide combined. This range includes any and all subranges therebetween, including for example about 10, 15, 20, 25, 30, 35, 40, 45, 50, 55, 60, 65, 70, 75, 80, 85, 90, 95, 96, 97, 98, 99, and less than 100 wt. %.

So long as it is present, the amount of silicon carbide powder present in the composition is not particularly limited and is easily determined given the teachings herein and the knowledge of one skilled in non-skid coatings. When determining the amount of silicon carbide powder, one may wish to consider the coating properties, toughness, impact and heat resistance, slip and wear resistance, rheology, corrosion resistance, handling and/or applicability properties, and the presence or absence of a primer coat, for example. In one embodiment, the silicon carbide powder is present in an amount ranging from greater than zero to about 60 wt. %, based on the weight of the silicon carbide powder to the weight of the novolac epoxy resin/silicon carbide powder in the non-skid composition. This range includes any and all subranges therebetween, including for example greater than zero, 0.1, 0.5, 0.75, 1, 2, 3, 4, 5, 6, 7, 8, 9, 10, 15, 20, 25, 30, 35, 40, 45, 50, 55, and 60 wt. %.

Epoxy novolac resins can be prepared by known methods for example by the reaction of an uncrosslinked phenol- or cresol-formaldehyde (novolac) or similar prepolymer with a halo-epoxy alkane. One example of a halo-epoxy alkane is epichlorohydrin. One example of a novolac prepolymer has the formula:

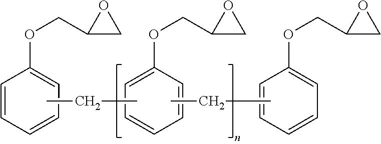

Examples of novolac epoxy resins include but are not limited to poly[(phenyl glycidyl ether)-co-formaldehyde (CAS #28064-14-4), average Mn is about 345. Other commercially available epoxy resins include those polyols and the like and polyglycidyl derivatives of phenol-formaldehyde novolacs such as those available under the tradenames DEN 431, DEN 438, and DEN 439 available from Dow Chemical Company. Cresol novolacs are also available commercially under the tradenames ECN 1235, ECN 1273, and ECN 1299 available from Ciba-Geigy Corporation. In one embodiment, the novolac is a phenol novolac epoxy resin. In another embodiment, the novolac is a cresol novolac epoxy resin. Combinations of phenol and cresol novolac epoxy resins may also be used.

The novolac epoxy resin may additionally include other agents such as glycidyl 2-methylphenyl ether (CAS #2210-79-9). One example of a commercially available novolac epoxy resin/silicon carbide is Corr-Paint 2060-B Base, a novolac-epoxy resin with silicon carbide filler, available from Aremco Products, Inc., in Valley Cottage, N.Y., USA, the MSDS of which is hereby incorporated by reference in its entirety.

So long as it is present, the amount of amine curing agent present in the composition is not particularly limited and is easily determined given the teachings herein and the knowledge of one skilled in non-skid coatings. When determining the amount of amine curing agent, one may wish to consider the coating properties, impact and heat resistance, handling and/or applicability properties, pot life, curing time, and amount of novolac epoxy resin, for example. In one embodiment, the amine curing agent is present in an amount ranging from about 1 wt. % to about 15 wt. %, based on the weight of the amine curing agent to the weight of the non-skid composition. This range includes any and all subranges therebetween, including for example about 1, 2, 3, 4, 5, 6, 7, 8, 9, 10, 11, 12, 13, 14, and 15 wt. %.

The amine curing agent contains at least one cycloaliphatic amine. Some examples of cycloaliphatic amines include 1,3-cyclohexane diamine, 1,4-cyclohexane diamine, 1-amino-3,3,5-trimethyl-5-aminomethyl-cyclohexane, 2,4-hexahydrotolylene diamine, 2,6-hexahydrotolylene diamine, 2,4′-diaminodicyclohexyl methane, 4,4′-diaminodicyclohexyl methane, 3,3′-dialkyl-4,4′-diamino-dicyclohexyl methane isophoronediamine, 3-aminomethyl-3,5,5-trimethylcyclohexyamine, and combinations thereof. One particularly suitable example is 3-aminomethyl-3,5,5-trimethylcyclohexyamine (CAS #2855-13-2).

Additional amine curing agents may be present, and may be selected from a wide variety of primary, secondary, tertiary amines, polyamines, and the like. Some examples of amine curing agents include aliphatic and aromatic amines, a Lewis base or a Mannich base. Combinations of additional amine curing agents are possible. Some example of aliphatic amines include alkylene diamines such as ethylene diamine, propylene diamine, 1,4-diaminobutane, 1,3-diaminopentane, 1,6-diaminohexane, 2,5-diamino-2,5-dimethylhexane, 2,2,4-trimethyl-1,6-diaminohexane, 1,11-diaminoundecane, 1,12-diaminododecane, trimethylhexamethylene diamine, triethylene diamine, piperazine-n-ethylamine, polyoxyalkylene diamines made from propylene oxide and/or ethylene oxide. Some examples of aromatic polyamines include 2,4- or 2,6-diaminotoluene and 2,4′- or 4,4′-diaminodiphenyl methane. Mixtures of amine curing agents may be employed. Commercially available amine curing agents may sometimes include residual amounts of solvents such as benzyl alcohol and others used in the manufacture of the compounds and, so long as their presence does not substantially detract from the properties of the non-skid composition and/or coating herein, unless otherwise stated they are within the ambit of the embodiments described herein.

The ratio of novolac epoxy resin to amine curing agent may be suitably selected and vary depending on the desired coating properties, handling and/or applicability properties, pot life, curing time, impact and heat resistance, the respective epoxide and reactive amine functionalities, and the like. In one embodiment, the weight ratio of the novolac epoxy resin to the amine curing agent ranges from 100:1 to 1:100. This range includes all values and subranges therebetween, including 100:1, 90:1, 80:1, 70:1, 60:1, 50:1, 40:1, 30:1, 20:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:20, 1:30, 1:40, 1:50, 1:60, 1:70, 1:80, 1:90, and 1:100 (weight novolac epoxy/silicon carbide: weight amine curing agent). Though not particularly limiting, in one embodiment, the molar ratio of the epoxide and amine functional groups may suitably range from about 0.25 to about 2.5, and in another embodiment is about 1:1.

One example of a commercially available amine curing agent is Corr-Paint 2060-A Activator, available from Aremco Products, Inc., in Valley Cottage, N.Y., USA, the MSDS of which is hereby incorporated by reference in its entirety.

So long as it is present, the amount of hydrophobic silica thixotrope agent present in the composition is not particularly limited and is easily determined given the teachings herein and the knowledge of one skilled in non-skid coatings. When determining the amount of hydrophobic silica thixotrope agent, one may wish to consider the coating properties, rheology, impact and heat resistance, corrosion resistance, handling and/or applicability properties, and the presence or absence of a primer coat, for example. In one embodiment, the hydrophobic silica thixotrope agent is present in an amount ranging from about 0.1 to about 5 wt. %, based on the weight of the hydrophobic silica thixotrope agent to the weight of the non-skid composition. This range includes any and all subranges therebetween, including for example about 0.1, 0.2, 0.3, 0.4, 0.5, 0.6, 0.7, 0.8, 0.9, 1, 2, 3, 5, and 5 wt. %.

One example of a commercially available hydrophobic silica thixotrope agent is CAB-O-SIL™ TS-720, a fumed silica treated with a dimethyl silicone fluid available from Cabot Corporation, Billerica, Mass., USA, the MSDS of which is hereby incorporated by reference.

So long as it is present, the amount of aluminum oxide powder present in the composition is not particularly limited and is easily determined given the teachings herein and the knowledge of one skilled in non-skid coatings. When determining the amount of aluminum oxide powder, one may wish to consider the coating properties, impact and heat resistance, slip and wear resistance, rheology, corrosion resistance, handling and/or applicability properties, and the presence or absence of a primer coat, for example. In one embodiment, the aluminum oxide powder is present in an amount ranging from about 20 wt. % to about 60 wt. %, based on the weight of the aluminum oxide powder to the weight of the non-skid composition. This range includes any and all subranges therebetween, including for example about 20, 25, 30, 35, 40, 45, 50, 55, and 60 wt. %.

The aluminum oxide powder has the following mesh retention characteristics, based on the weight of the aluminum oxide powder:

about 0 wt. % size 10 mesh,

≧ about 5 wt. % size 16 mesh,

≧ about 20 wt. % size 18 mesh,

≧ about 10 wt. % size 20 mesh,

and ≦ about 5 wt. % size 30 mesh.

The aluminum oxide powder contains about 0 wt. % size 10 mesh powder. This means that substantially no particles of aluminum oxide powder larger than size 10 mesh are present in the aluminum oxide powder.

The aluminum oxide powder contains greater than or equal to about 5 wt. % size 16 mesh powder. This means that about 5 wt. % or more of the aluminum oxide powder is retained on size 16 mesh. In one embodiment, the amount of size 16 mesh aluminum oxide powder may range from about 5 wt. % to about 30 wt. %, based on the total weight of the aluminum powder. This amount includes any and all subranges therebetween, for example including about 5, 10, 15, 20, 25, and 30 wt. %.

The aluminum oxide powder contains greater than or equal to about 20 wt. % size 18 mesh powder. This means that about 20 wt. % or more of the aluminum oxide powder is retained on size 18 mesh. In one embodiment, the amount of size 18 mesh aluminum oxide powder may range from about 20 wt. % to about 70 wt. %, based on the total weight of the aluminum powder. This amount includes any and all subranges therebetween, for example including about 20, 25, 30, 35, 40, 45, 50, 55, 60, 65, and 70 wt. %.

The aluminum oxide powder contains greater than or equal to about 10 wt. % size 20 mesh powder. This means that about 10 wt. % or more of the aluminum oxide powder is retained on size 20 mesh. In one embodiment, the amount of size 20 mesh aluminum oxide powder may range from about 10 wt. % to about 50 wt. %, based on the total weight of the aluminum powder. This amount includes any and all subranges therebetween, for example including about 10, 15, 20, 25, 30, 35, 40, 45, and 50 wt. %.

The aluminum oxide powder contains less than or equal to about 5 wt. % size 30 mesh powder. This means that about 5 wt. % or less of the aluminum oxide powder is retained on size 30 mesh. In one embodiment, the amount of size 30 mesh aluminum oxide powder may range from about 5 wt. % to about 0 wt. %, based on the total weight of the aluminum powder. This amount includes any and all subranges therebetween, for example including about 5, 4, 3, 2, 1, 0.1 and 0 wt. %.

The mesh size of the aluminum oxide powder may be determined in accordance with ANSI B74.12-2001, in which testing sieves are calibrated to conform to ASTM Standard E-11. These standards are hereby incorporated by reference. Screen analysis may be performed on a representative 100-gram sample of the powder, which may be obtained utilizing a mechanical sample splitter. A standard make rotating and tapping type of testing machine may be used.

In one embodiment, the aluminum oxide powder is substantially pure Al₂O₃, but may contain insubstantial amounts of other metals and/or metal oxides, for example, titanium dioxide, silicon dioxide, iron oxide, sodium oxide, magnesium oxide, calcium oxide, and the like. In one embodiment, the aluminum oxide powder contains Al₂O₃ powder in amounts ranging from about 95 wt. % to about 100 wt. %, based on the weight of the aluminum oxide powder. This amount includes any and all subranges therebetween, including for example about 95, 96, 97, 98, 99, and 100 wt. %.

In one embodiment, the aluminum oxide powder has a specific gravity of 3.98, bulk density of 2.03, friability of 35.8, hardness Koop 10 of 2050, and moisture content of about 0. One example of a commercially available aluminum oxide powder is V-Blast or ALOX-20™, a brown fused aluminum oxide powder available from GMA Industries, Inc., in Romulus, Mich., USA.

In one embodiment, the composition contains about 30-70 wt. % of the novolac epoxy resin/silicon carbide powder; 1-15 wt. % of the amine curing agent; 0.05-5 wt. % of the hydrophobic silica thixotrope; and 20-60 wt. % of the aluminum oxide powder.

In one embodiment, the composition contains about 40-60 wt. % of the novolac epoxy resin/silicon carbide powder; 2-10 wt. % of the amine curing agent; 0.1-5 wt. % of the hydrophobic silica thixotrope; and 25-55 wt. % of the aluminum oxide powder.

In one embodiment, the composition contains about 45-55 wt. % of the novolac epoxy resin/silicon carbide powder; 3-7 wt. % of the amine curing agent; 0.5-2 wt. % of the hydrophobic silica thixotrope; and 30-50 wt. % of the aluminum oxide powder.

In one embodiment, the composition contains about 45-55 wt. % of a phenolic novolac epoxy resin/silicon carbide powder; 3-7 wt. % of the amine curing agent, the amine curing agent comprising a mixture of cycloaliphatic and aliphatic amines; 0.5-2 wt. % of the hydrophobic silica thixotrope; and 30-50 wt. % of the aluminum oxide powder.

In one embodiment, the aluminum oxide powder has the following mesh retention characteristics, based on the weight of the aluminum oxide powder:

about 0 wt. % size 10 mesh,

about 10-20 wt. % size 16 mesh,

about 55-65 wt. % size 18 mesh,

about 20-30 wt. % size 20 mesh,

and about 0-0.5 wt. % size 30 mesh.

The non-skid coating may be suitably applied to a surface with a sprayer, trowel, brush, roller, or combination thereof. The uncured coating composition is prepared by contacting and thoroughly mixing the ingredients. In one embodiment, the thus-produced uncured coating composition is then applied to a surface with a trowel, or poured onto the surface; followed by further troweling, brushing, rolling, or a combination thereof as appropriate. The trowel, brush, or roller may be made of any material suitable for applying epoxy coatings. Suitable rollers, for example, are made from plastic, metal or other inert material such as polyvinylchloride, aluminum, or phenolic material, and may have smooth or textured surfaces. In one embodiment, a smooth (i.e., napless) phenolic roller is used. The smooth roller without any hair creates a suitably textured surface by pulling upon the coating during application and creating ridges and troughs when rolled. The surfaces of these ridges and troughs contribute to the non-skid profile of the coating. The thus-applied coating is then allowed to cure.

The ordinary definition of the term, “curing” in polymer chemistry is adopted herein. For amine-cured epoxy polymers, the curing process typically involves one or more crosslinking reactions between the reactants to form a thermoset polymer. A cured coating results when most or substantially all of the crosslinking reactions have taken place.

The curing time is not particularly limiting, and may depend on variables such as pot life, the amount of epoxy resin and/or amine curing agent used, the respective functionalities of epoxy resin and amine curing agent used, temperature, presence or absence of solvent, and the like. Examples of curing times may range from about 1 hour or less to about 96 hours or longer. This range includes all values and subranges therebetween, including 0.5, 1, 2, 3, 4, 5, 6, 7, 8, 9, 10, 12, 14, 16, 18, 20, 22, 24, 30, 36, 48, 72, 84, 96, and 100 hours or more. In one embodiment, the curing time is about 3 hours at about 75° F.

The curing temperature is not particularly limiting, and may depend on variables such as pot life, the amount of epoxy resin and/or amine curing agent used, the respective functionalities of epoxy resin and amine curing agent used, time, presence or absence of solvent, and the like. Examples of curing temperatures may range from about 32° F. or less to about 110° F. or more. This range includes all values and subranges therebetween, including 32, 34, 36, 38, 40, 45, 50, 55, 60, 65, 70, 75, 80, 85, 75, 80, 85, 90, 95, 100, 105, 110° F. or more.

Optionally, the non-skid coating composition may be made from 100% or nearly 100% solids components obtained from a supplier without further dilution, i.e., without or substantially without the addition of volatile solvents. As used herein, a solvent such as water or an organic compound refers to materials that dissolves the epoxy resin and/or amine starting materials, and which evaporates from the coating upon application and/or exposure to an open environment (such as to air). Representative examples of such volatile organic solvents that may be advantageously absent from the non-skid composition include low molecular weight halogenated hydrocarbons such as chloroform and carbon tetrachloride, xylenes, hydrocarbons, alcohols, ketones, ethers, glycol ethers, and so forth. In one embodiment, one or more of the coating composition, resin package, or amine package independently contains less than about 40 wt. % of solvents, based on the respective weight of coating composition, resin package, or amine package. This amount includes any and all subranges therebetween, for example including less than about 40, 35, 30, 25, 20, 15, 10, 5, 4, 3, 2, 1, and 0 wt. %. In one embodiment, none of the coating composition, resin package, or amine package contains any or substantially any solvent.

Though not required, additional abrasive materials may be added to the non-skid coating composition. The additional abrasive may be selected from a wide variety of materials. The additional abrasives may optionally be employed to provide additional non-skid properties or filling properties to the coating. Some examples of these include metals such as aluminum, pumice, garnet, sand, gravel, silica, ceramic fibers or whiskers such as of magnesium oxide, aluminum nitride, boron nitride, zinc oxide, crushed glass, quartz, polymer, rubber, and combinations thereof. The additional abrasive may be added to either the resin side or to the amine side. In one embodiment, additional abrasives may be present in an amount less than 30 wt. %, based on the total weight of the composition. This amount includes any and all subranges therebetween, for example including less than about 30, 25, 20, 15, 10, 5, 4, 3, 2, 1, and 0 wt. %. In one embodiment, the base non-skid composition (e.g., novolac epoxy resin comprising silicon carbide powder, amine curing agent, hydrophobic silica thixotrope agent, and aluminum oxide powder) referred to herein does not contain additional abrasive.

Though not required, one or more corrosion inhibitors may be added to the non-skid coating composition. These serve to eliminate, reduce or retard the amount of corrosion of the underlying substrate or coating/substrate interface. The corrosion inhibitors may be selected from a wide variety of materials. Some examples of corrosion inhibitors include zinc-based inhibitors such as zinc phosphate, zinc-5-nitro-isophthalate, zinc molybdate, zinc oxide, calcium molybdate, calcium carbonate, calcium zinc molybdate, and hydrophobic, moisture penetration inhibitors such as hydrophobic, amorphous fumed silica. Combinations of corrosion inhibitors are possible. Some examples of commercially available corrosion inhibitors include HALOX™ 750, a zinc oxide based material available from HALOX of Hammond, Ind., USA; MOLY-WHITE™ MZAP or MWMZAP, a basic calcium zinc molybdate material available from Moly-White of Coffeyville, Kans., USA; and CAB-O-SIL™ TS-720 treated fumed silica. These may be in any amount effective to provide corrosion inhibition. In one embodiment, one or more corrosion inhibitors may be present in an amount less than 15 wt. %, based on the total weight of the composition. This amount includes any and all subranges therebetween, for example including less than about 15, 10, 9, 8, 7, 6, 5, 4, 3, 2, 1, 0.5, 0.1, 0.01, and 0 wt. %.

Though not required, one or more UV stabilizer may be added to the non-skid coating composition. The UV stabilizer serves to protect the cured coating from the harmful effects of UV light, and may be selected from a wide variety of materials. Some examples of UV stabilizers include sterically hindered piperidine derivatives including an alkyl substituted hydroxy piperidines such as dimethyl 4-methoxybenzylidene malonate, dimethyl sebacate, methyl-1,2,2,6,6-pentamethyl-4-piperidinyl sebacate, bis(1,2,2,6,6-pentamethyl-4-piperidinyl)sebacate, hindered amine light stabilizers (HALS), benzotriazoles, triazines, and 1,2,2,6,6-pentamethyl-4-piperidinol. Combinations of stabilizers are possible. The UV stabilizer may be used in any amount effective to provide UV stabilization. In one embodiment, one or more UV stabilizers may be present in an amount less than 10 wt. %, based on the total weight of the composition. This amount includes any and all subranges therebetween, for example including less than about 10, 9, 8, 7, 6, 5, 4, 3, 2, 1, 0.5, 0.1 and 0 wt. %. Some examples of commercially available UV stabilizers include Hostavin PR-25, available from Clariant International, Ltd. of Muttenz, Switzerland; and TINUVIN™ 5060, available from CIBA™ Corporation, Tarrytown, N.Y., USA.

Though not required, one or more pigments may be added to the non-skid coating composition. These serve to impart a color to the composition, and they may be selected from a wide variety of materials. For example, if a gray coating is desired, white and black pigments can be used. If a yellow coating is desired, then yellow pigments can be employed, and so on. The so-called high solar reflectance, low thermal emittance (HSR/LTE) pigments may also be included in the non-skid coating composition. Such pigments can help to reduce solar absorption and heat re-radiation. Some examples of these include iron oxide, titanium dioxide, and phthalocyanine pigments. A representative example of a darkening pigment is black iron oxide. Black iron oxide also has the desirable property of being infrared transparent and thus may serve as an infrared (IR) transparent darkening agent. This may be desirable to eliminate, reduce or retard IR absorption by the composition, which helps to keep the coated surface cool. Alternatively, or in combination, an IR reflector may be included in the non-skid composition. One such IR reflector is titanium dioxide, which may also serve as a pigment. By reflecting IR light, the coating may be less prone to becoming heated in sunlight. The pigments may be present in any amount effective to impart color, increase IR reflectance, reduce thermal emittance, or any combination thereof. In one embodiment, one or more pigments may be present in an amount less than 15 wt. %, based on the total weight of the composition. This amount includes any and all subranges therebetween, for example including less than about 15, 10, 9, 8, 7, 6, 5, 4, 3, 2, 1, 0.5, 0.1, and 0 wt. %. One example of a commercially available pigment is Shepherd Black 30C940, a chromium green-black hematite pigment available from The Shepherd Color Company, Cincinnati, Ohio, USA.

Though not required, one or more fire retardants may be added to the non-skid coating composition. Some examples of these include alumina such as alumina trihydrate, magnesium hydroxide, bismuth oxide, zinc borate, potassium tripolyphosphate, antimony oxide, and ceramic spheres. Combinations of fire retardants are possible. Some examples of combinations include magnesium hydroxide with alumna trihydrate, and zinc borate with magnesium hydroxide and/or alumna trihydrate. The fire retardants may be suitably employed to reduce, eliminate, or retard the ability of the coating to sustain a fire. In one embodiment, one or more fire retardants are present in an amount less than 40 wt. %, based on the total weight of the composition. This amount includes any and all subranges therebetween, for example including less than about 40, 35, 30, 25, 20, 15, 10, 5, 4, 3, 2, 1, and 0 wt. %. One example of a commercially available fire retardant is Hy-Tech Ceramic Insulating additive, available from Hy-Tech of Melbourne, Fla., USA.

Though not required, the non-skid coating composition may additionally include one or more impact toughening agents. These toughening agents, if present in addition to the base non-skid coating composition, may be present in an amount ranging from about 0.01 to about 10 wt. %, based on the total weight of the composition. In one embodiment, an impact toughening agent is not included.

If desired, the non-skid coating composition may be conveniently packaged in a kit for ease of shipment and/or application. In one embodiment of such a kit, a resin package and a curing agent package are provided. The resin and curing packages may contain the respective resin, amine, silica thixotrope, and aluminum oxide ingredients in premeasured amounts, if desired. To use the kit, one may conveniently contact the contents of the resin package with the contents of the curing agent package, mix, and apply to a surface.

As noted herein, the non-skid coating composition may be applied to any suitable surface on which a durable non-skid is desired. The surface may be prepared according to any of the well known techniques. Examples of such techniques include the protocol SSPC-SP-10 (near white metal) or SSPC-SP-12 (waterjetted), both protocols incorporated herein by reference, or a combination thereof.

The surface may be bare, or as treated above, it may have one or more primer coats, or a combination thereof. In one embodiment, no primer is used. In another embodiment, a primer is used between the surface and the non-skid coating, which primer comprises:

a novolac epoxy resin comprising silicon carbide powder; and

an amine curing agent, said agent comprising at least a cycloaliphatic amine.

The amounts of the novolac epoxy resin/silicon carbide powder and amine curing agent in the primer may be the same or different as those set out for the base non-skid composition and coating described herein. The primer may appropriately serve to promote adhesion, reduce corrosion, reduce thermal conductivity to the underlying surface, and combinations thereof. The primer may optionally include one or more corrosion inhibitors, fire retardants, and the like in the amounts described herein for the base non-skid composition. One example of a commercially available primer is CP2060 available from Aremco Products, Inc., in Valley Cottage, N.Y., USA, the MSDS of which is hereby incorporated by reference in its entirety. This primer may be sprayed, troweled, rolled, brushed, or a combination thereof onto the surface.

In one embodiment, a thermal barrier coat (“TBC”) is optionally applied as a primer. In another embodiment, the primer coat is a two-layer thermal barrier coating (“TBC”), which is applied to the substrate prior to applying the epoxy non-skid coating. One example of such a thermal barrier coat (TBC) is a sprayed ceramic coating. Ceramic coatings have a low thermal conductivity and may help to prevent the penetration of heat through the underlying substrate into protected components. Currently available thermal barrier coatings (TBC's) are capable of reducing the average temperatures of metallic components by 90 to 150° F. Peak temperatures can be reduced up to 290° F. Zirconia based thermal barrier coatings have a thermal conductivity that is 10% of most metals and may be desirable in terms of high thermal expansion coefficient, low thermal conductivity, chemical stability, and thermal shock resistance.

One example of a two-layer thermal barrier coating (“TBC”) includes a first metallic sprayed-on bond coat and a second yttria stablilized zirconia topcoat. The inventors have found that yttria stabilized zirconia topcoat is particularly suitable in a TBC because of its low thermal conductivity and relatively high thermal expansion coefficient. When used with an epoxy non-skid coating composition, the TBC provides oxidation and hot corrosion resistance and good thermal conductivity protection to the underlying surface from environmental and heat degradation. Surprisingly, the combination of the TBC layer and epoxy coating decreases the cyclic temperature load on the underlying surface, increases long term stability and long term performance of the non-skid coating, and reduces the thermal expansion mismatch with the high thermal expansion coefficient of non-skid coating with which it is applied.

The combination of epoxy non-skid and TBC is particularly suitable for use on substrates exposed to hostile thermal environments such as the MV-22 gas turbine engines or aircraft jet engines.

Such TBC coatings are known. They may be suitably applied to a clean substrate using high velocity oxy-fuel (HVOF) plasma thermal spraying.

The type and thickness of the metallic sprayed-on bond coat for the TBC is not particularly limited. For example, the bond coat may be applied to a substrate to a thickness between about 0.001″ and about 0.10″ using high velocity oxy-fuel (HVOF) plasma thermal spraying, which range includes all values and subranges therebetween, including about 0.001, 0.002, 0.003, 0.004, 0.005, 0.006, 0.007, 0.008, 0.009, 0.010, 0.020, 0.030, 0.040, 0.050, 0.060, 0.070, 0.080, 0.090, 0.10″, and greater, and any combination thereof. In one embodiment, the bond coat may be applied to a thickness of 0.005″ to 0.010″.

One example of a metallic sprayed-on bond coat includes Sulzer Metco 461NS (NiCr—Al—Co—Y₂0₃) metallic sprayed-on bond coat. This bond coat may be applied to a substrate to a thickness between about 0.001″ and about 0.10″ using high velocity oxy-fuel (HVOF) plasma thermal spraying, which range includes all values and subranges therebetween including about 0.001, 0.002, 0.003, 0.004, 0.005, 0.006, 0.007, 0.008, 0.009, 0.010, 0.020, 0.030, 0.040, 0.050, 0.060, 0.070, 0.080, 0.090, 0.10″, and greater, and any combination thereof. In one embodiment, the bond coat may be applied to a thickness of 0.005″ to 0.010″.

The type and thickness of the yttria-stabilized zirconia topcoat for the TBC is not particularly limited. For example, the topcoat may be applied to a substrate to a thickness between about 0.005″ and about 0.40″ using high velocity oxy-fuel (HVOF) plasma thermal spraying, which range includes all values and subranges therebetween, including about 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.2, 0.25, 0.3, 0.35, and 0.4″, and greater, and any combination thereof. In one embodiment, the bond coat may be applied to a thickness of 0.01″ to 0.020″.

One example of a yttria-stabilized zirconia topcoat includes Sulzer Metco 204N-NS yttria stabilized zirconia topcoat. It is available as a powder and may be flame applied using high velocity oxy-fuel (HVOF) plasma thermal spraying. The topcoat may be applied to a substrate to a thickness between about 0.005″ and about 0.40″ using high velocity oxy-fuel (HVOF) plasma thermal spraying, which range includes all values and subranges therebetween, including about 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.2, 0.25, 0.3, 0.35, and 0.4″, and greater, and any combination thereof. In one embodiment, the bond coat may be applied to a thickness of 0.01″ to 0.020″.

The TBC can be applied under either the novolac non-skid coating composition described herein (e.g., which may contain the novolac epoxy resin comprising silicon carbide powder, amine curing agent comprising at least a cycloaliphatic amine, a hydrophobic silica thixotrope agent, and aluminum oxide powder having the stated mesh retention characteristics) or under any conventional non-skid coating system qualified to MIL-PRF-24667.

One embodiment includes a novolac non-skid coating described herein (e.g., which may contain the novolac epoxy resin comprising silicon carbide powder, amine curing agent comprising at least a cycloaliphatic amine, a hydrophobic silica thixotrope agent, and aluminum oxide powder having the stated mesh retention characteristics) with a TBC undercoat. Another embodiment includes a surface having coated thereon the novolac non-skid coating described herein with a TBC undercoat. Another embodiment includes a kit, which includes the novolac non-skid coating composition described herein (novolac epoxy resin comprising silicon carbide powder, amine curing agent comprising at least a cycloaliphatic amine, a hydrophobic silica thixotrope agent, and aluminum oxide powder having the stated mesh retention characteristics, in any combination) and a TBC composition (e.g., metallic bond coating composition and yttria stabilized zirconia composition) which may be sold together in a package, or as separate components in a package. Another embodiment includes a method for coating a surface, which method includes applying a TBC undercoat, and then applying the novolac non-skid composition as a coating thereover.

Yet another embodiment includes a conventional non-skid epoxy coating with a TBC undercoat. Another embodiment includes a surface having coated thereon a conventional non-skid epoxy coating with a TBC undercoat. Another embodiment includes a kit, which includes a conventional non-skid epoxy composition (e.g., epoxy resin and activator) and a TBC composition (e.g., metallic bond coating composition and yttria stabilized zirconia composition) which may be sold together in a package, or as separate components in a package. Another embodiment includes a method for coating a surface, which method includes applying a TBC undercoat, and then applying a conventional epoxy non-skid coating thereover.

Conventional epoxy coating systems qualified to MIL-PRF-24667 include, for example, products such as INTERSHIELD 6GV™ manufactured by International Marine Coatings. This is an epoxy nonskid containing a resin (oxirane, 2,2′-4-butylidenebisphenyleneoxymethylene), an amine curing agents with pigments, fire retardants, aggregates and other filler agents. Another example of a conventional non-skid coating system qualified to MIL-PRF-24667 is MS-400G™ or MS-400L™ available from ITW American Safety Technologies. These conventional epoxy non-skid compositions include a Bis-phenol A epoxy resin with amine curing agents, pigments, fire retardants, a nonskid aggregate with aluminum oxide or aluminum granules, and other filler materials.

Another example of a conventional non-skid coating system qualified to MIL-PRF-24667 is Amercoat 138G™ available from PPG Industries. This is an epoxy non-skid which contains epoxy resin with amine curing agents, pigments, fire retardants, a nonskid aggregate with aluminum oxide, and other filler materials.

Other conventional non-skid compositions and/or epoxies include those described in U.S. Pat. Nos. 4,760,103; 4,859,522; 5,686,507; 6,779,486; 7,037,958, and 7,465,477; and 6,248,204, for example, the contents of each of which being individually incorporated herein by reference.

The non-skid composition is easy to prepare and apply. Surprisingly, even though the resulting non-skid coating exhibits vastly superior impact and heat resistance and other properties, the non-skid coating is easily removable with high or ultra high pressure water jetting (UHP water jetting). The non-skid coating can be removed, and the underyling surface or TBC is not harmed.

The non-skid composition and coating inhere other advantages. Testing has proven the non-skid coating's ability to resist temperatures of 400° F. for 90 minutes without an effect on impact resistance or other mechanical properties. The non-skid is resistant to thermal cycling, accelerated aging, chemicals, and seawater immersion. The non-skid coating desirably resists cyclic deck flexure; provides thermal insulation to surrounding deck; maintain slip resistance; is easily mixed and applied; is resistant to corrosion and environmental effects; resists impact; is compatible with existing deck structure; meets MILSPEC MIL-PRF-24667B (incorporated herein by reference); and resists erosion from direct heat impingement.

### EXAMPLES

In the examples below, which are not intended to be limiting, exemplary non-skid coatings in accordance with one or more embodiments described herein are compared to a commercially available conventional non-skid coating.

Test Panel—Exemplary Formula No. 1

Exemplary Formula No. 1 was prepared in accordance with one embodiment described herein using:

Component A: 51.6 oz. Novolac epoxy resin with silicon carbide powder (Corr-Paint 2060-B Base, available from Aremco Products, Inc., in Valley Cottage, N.Y., USA);

Component B: 4.6 oz. Cycloaliphatic amine/aliphatic amine activator (Corr-Paint 2060-A Activator, available from Aremco Products, Inc., in Valley Cottage, N.Y., USA)

Component C: 0.7 oz. Synthetic, treated fumed hydrophobic silica thixotrope (CAB-O-SIL™ TS-720, a fumed silica treated with a dimethyl silicone fluid available from Cabot Corporation, Billerica, Mass., USA);

Component D: 40 oz. Distributed aluminum oxide abrasive aggregate; 96% pure Al₂O₃; (of this 40 oz., 0% by weight mesh particle size 10; 14.0% by weight mesh particle size-16; 60.3% by weight mesh particle size-18; 25.6% by weight mesh particle size-20; and 0.1% by weight mesh particle size-30).

Components A, C, and D were combined and mixed in a commercial tolling machine. Component B was added, and mixed, to form Formula No. 1.

Part 1 Initial Evaluation

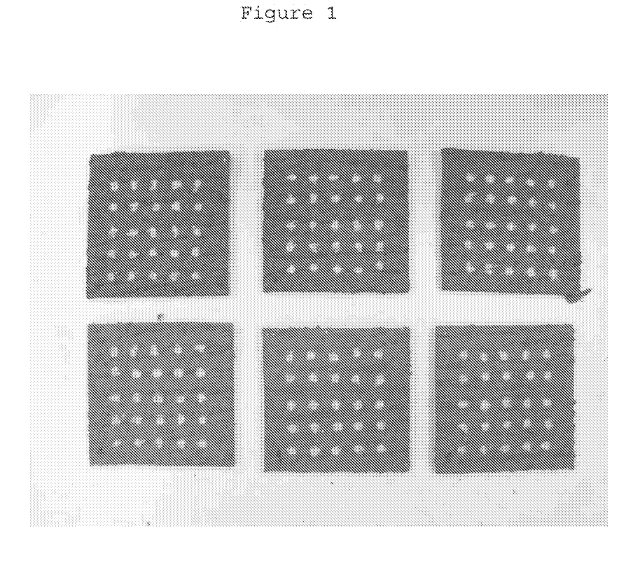

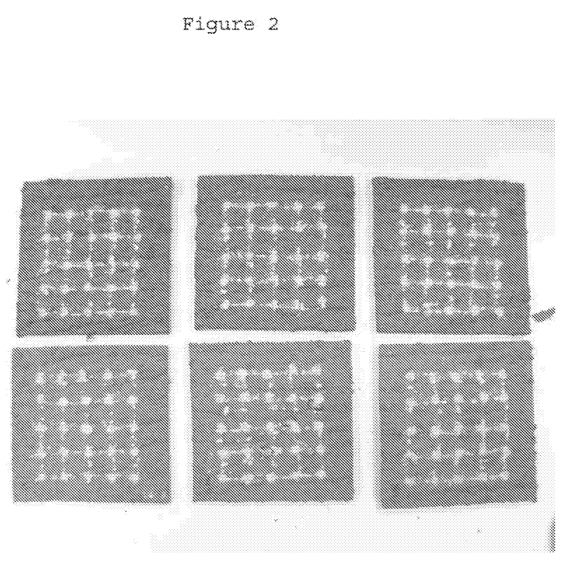

Six steel panels were grit blasted to between 3 and 4 mils final surface roughness based on a Keane-Tator surface profile comparator disk. The panels were coated with Formula No. 1 using a phenolic application roller. The panels were allowed to harden at room temperature and aged at 250° F. Three panels were heat exposed at 400° F. for 90 min. The surface of the heat exposed panels discolored to an olive green shade. No defects (e.g. softening, blistering or cracks) were noted after heat exposure. The impact resistance of the six coated panels was tested in accordance with MIL-PRF-24667B. The drop height was 4 ft. The drop weight was 4.02 lbs and tipped with a ⅝ inch ball striker. The impact sequence was as specified forming a 5×5 test pattern. The impacted plates were subsequently probed with a 1 inch cold chisel. The bridges between impacts were struck using the chisel at a 45 degree angle with a 1.5 lb hammer. Only minor surface chipping was observed. The six panels are illustrated in FIGS. 1 and 2.

The three room temperature cured panels (bottom row in FIGS. 1 and 2) all passed MIL-PRF-24667B with a rating of 100.

The three panels heat-exposed at 400° F. (top row in FIGS. 1 and 2) all passed MIL-PRF-24667B with a rating of 100.

Part 2 Additional Evaluation

Additional steel test panels (Samples A-F) were coated with Formula No. 1 in accordance with embodiments described herein and were tested as follows:

| Samples | Count | Size | Process | Test |
|---|---|---|---|---|
| A: Thermal | 2 | 6″ × 6″ × 0.25″ | 10 cycles | Impact |
| Aging | | | 400° F. | Test |
| B: Seawater | 2 | 6″ × 6″ × 0.25″ | 15 days | Impact |
| Exposure | | | immersion | Test |
| C: Flame | 2 TBC | 6″ × 6″ × 0.25″ | As received | Impact |
| sprayed TBC | | | | Test |
| D | 3 | 4″ × 6″ × 0.125″ | 200 hrs UV/ | Coating |
| Accelerated | | | Humidity | Inspection |
| Ageing | | | cycles | |
| E & F | 3 | 4″ × 6″ × 0.125″ | 1000 hours salt | Coating |
| Accelerated | 1 TBC | 6″ × 6″ × 0.25″ | fog | Inspection |
| Corrosion | | | | |

Impact Testing

Sample A panels with the Formula No. 1 non-skid coating were heat exposed at 400° F. for 10 cycles in an air-circulating oven. The thermal profile was 1 hour ramp-up 80° F.-400° F., 1.5 hours soak at 400° F., 1.5 hours ramp-down, 2 hours stabilize at 80° F. The coatings turned a deep brown. No defects (e.g. blistering or cracks) were noted after heat exposure cycling.

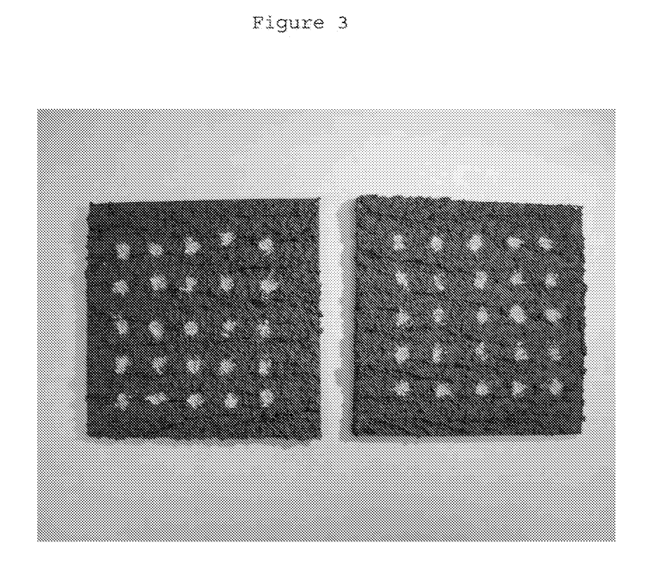

Sample A panels were tested in accordance with MIL-PRF-24667B. The drop height was 4 ft. The drop weight was 4.02 lbs and tipped with a ⅝ inch ball striker. The impact sequence was as specified forming a 5×5 test pattern. The impacted plates were probed with a 1 inch cold chisel. The coatings did not lift and no bridges between impact points were removed. Both Sample A panels passed MIL-PRF-24667B with a rating of 100. The panels are illustrated in FIG. 3.

Sample B panels with the Formula No. 1 non-skid coating on the front were coated on the exposed steel back with a sealer. The panels were then immersed in artificial seawater (per ASTM D1141, incorporated herein by reference) for 15 days. The pH of the seawater was monitored and stayed constant between 7.9 and 8.1. The immersed panels did not change the pH of the seawater over the 15 days immersion period.

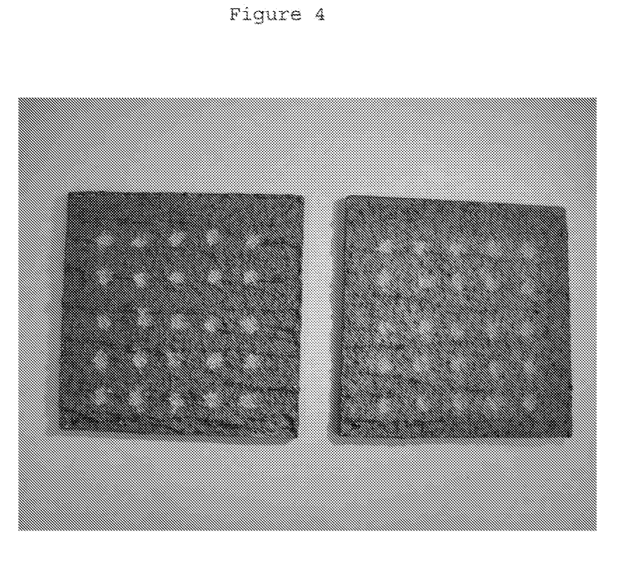

Sample B panels were tested immediately on removal from the seawater. Impact testing was in accordance with MIL-PRF-24667B as above. The coatings did not lift and no bridges between impact points were removed. Two Sample B panels both passed MIL-PRF-24667B with a rating of 100. The panels are illustrated in FIG. 4.

Sample C panels were submitted with a two-layer thermal barrier coating (“TBC”), which includes a first metallic sprayed-on bond coat and a second yttria stablilized zirconia topcoat. Prior to applying the Formula 1 coating, the sandblasted steel panels were coated with a Sulzer Metco 461NS (NiCr—Al—Co—Y₂O₃) metallic sprayed-on bond coat applied to a thickness between 0.005″ and 0.010″ using high velocity oxy-fuel (HVOF) plasma thermal spraying, and thereafter a topcoat of Sulzer Metco 204N-NS yttria stabilized zirconia powder applied to a thickness between 0.01″ and 0.02″ thick using high velocity oxy-fuel (HVOF) plasma thermal spraying. The Formula No. 1 non-skid was applied on top of the deposited TBC layer. Sample C panels were impact tested in accordance with MIL-PRF-24667B as above. The coatings did not lift and no bridges between impact points were removed.

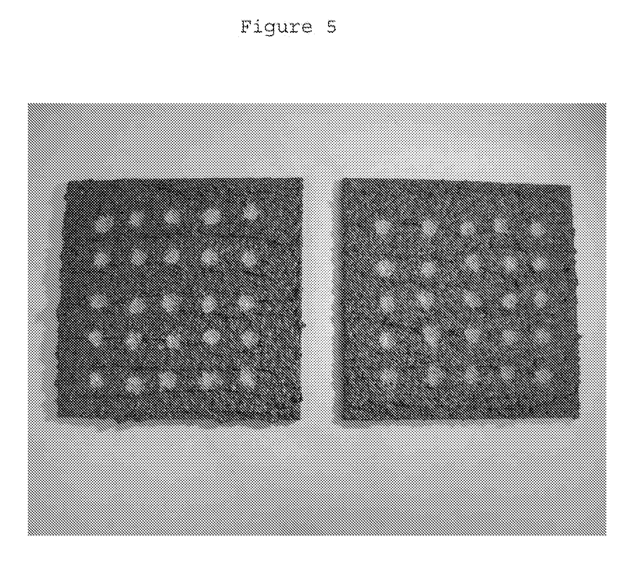

Two Sample C panels both passed MIL-PRF-24667B with a rating of 100. The panels are illustrated in FIG. 5.

Accelerated Ageing—Environmental Testing

Sample D panels with the Formula No. 1 non-skid coating on the front were coated on the exposed steel back with a sealer. One panel was then tested as received, and two panels were first impacted in two locations using the described drop tester.

Sample D panels were aged in a QUV accelerated aging tester for 200 hours exposure cycling per ASTM G154 Table X2.1 Cycle 2 (incorporated herein by reference). The cycle was 4 hours UV-B exposure at 60° C. followed by 4 hours humidity condensation at 50° C.

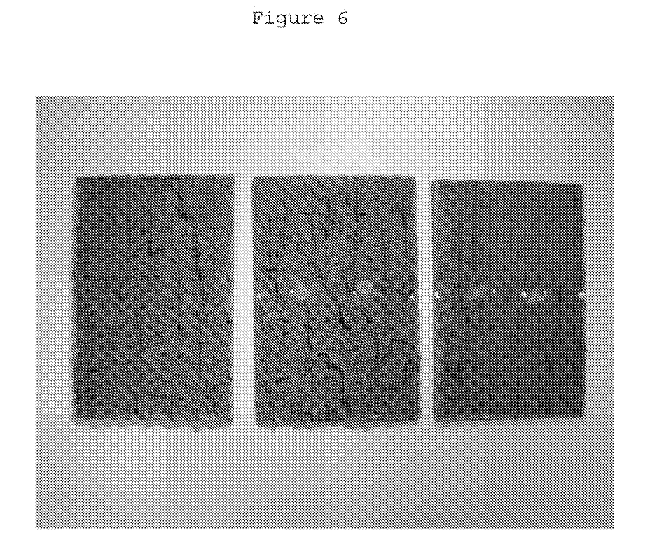

The Sample D non-impacted panel showed no defects (e.g. rusting, blistering, cracks or lifting of the coating) after QUV accelerated ageing as illustrated in FIG. 6.

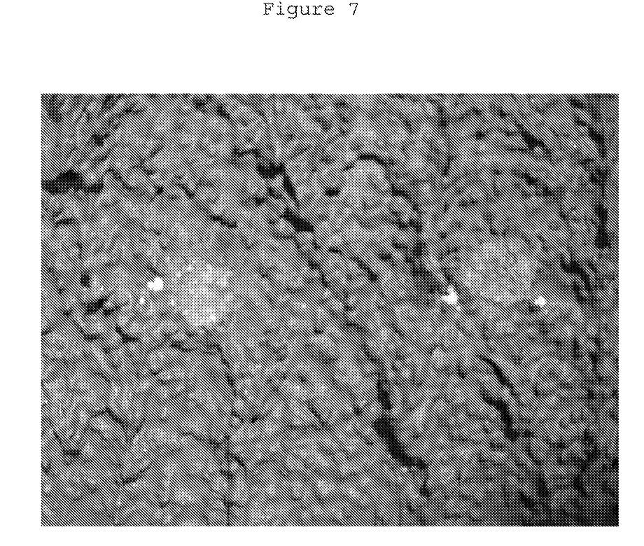

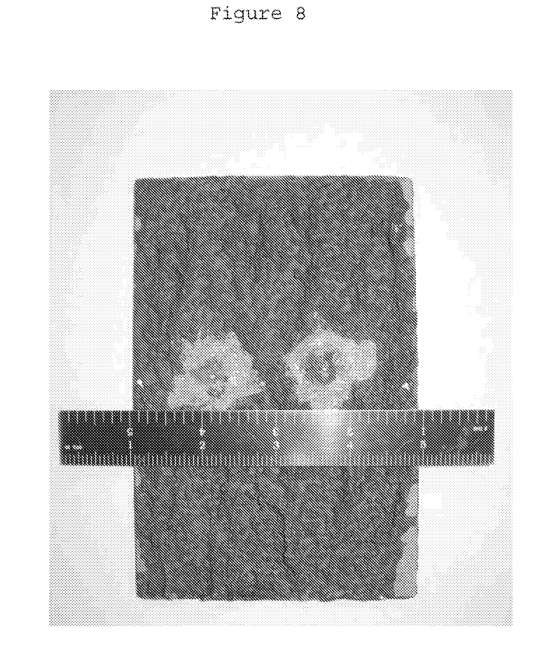

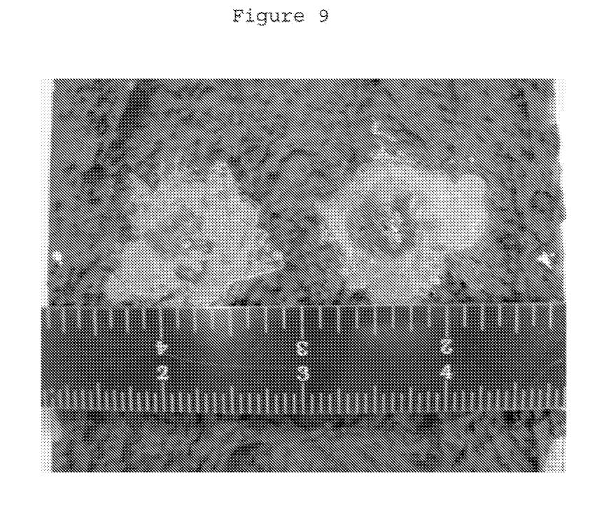

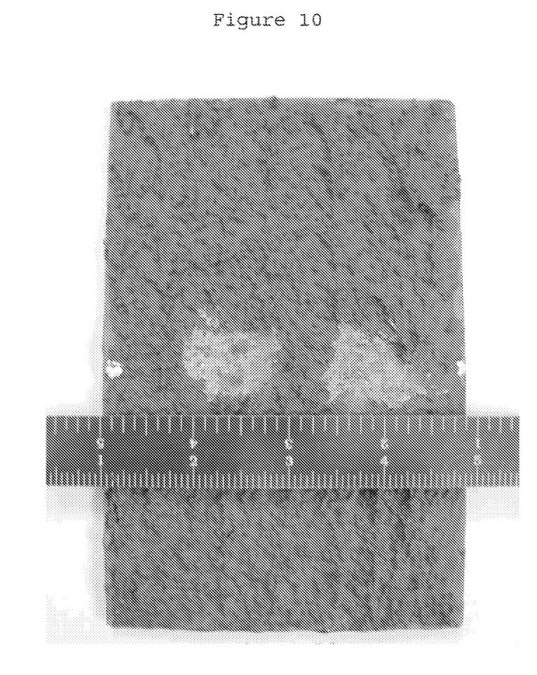

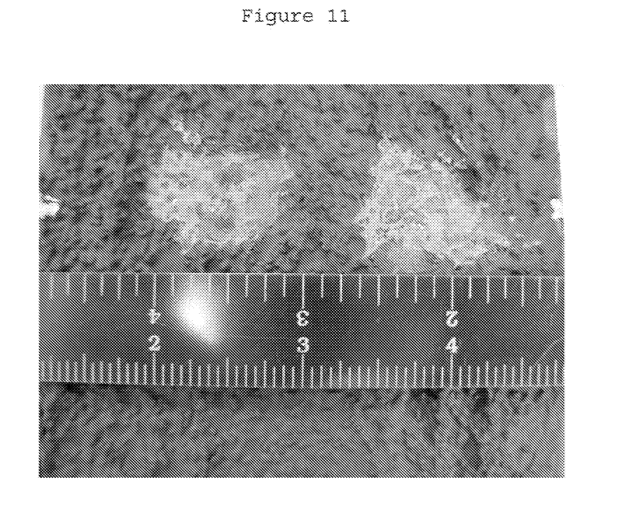

The two Sample D impacted panels showed fine rust spots forming in the impacted coating depressions (see FIGS. 6 and 7), but otherwise no apparent defects (e.g. blistering, cracks or lifting of the coating) after QUV accelerated ageing. The impacted panels were examined by marking the center of impact with a drill and chipping to remove the coating and expose the steel using a ¼″ wide chisel and hammer. The examination is illustrated in FIGS. 8-11. The corrosion had not expanded much beyond the impacted zone. Even after impact and QUV aging, these Sample D panels passed MIL-PRF-24667B.

Accelerated Corrosion—Environmental Testing

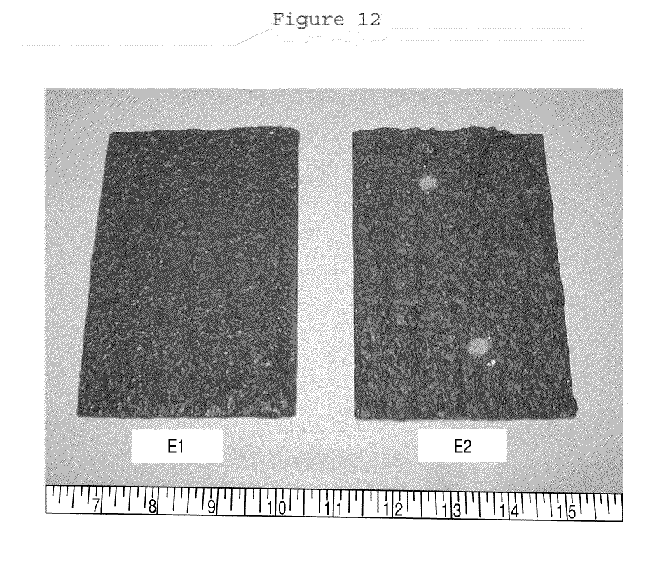

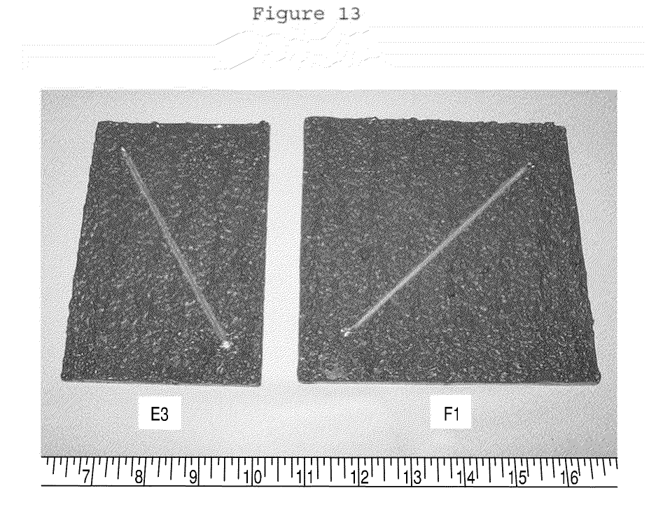

Sample E and F panels with the Formula No. 1 non-skid coating were coated on the exposed steel back with a sealer. Sample E panels were coated with Formula 1 coating, and the Sample F panel had a Formula 1 over the TBC coating described for Sample C. Panel E1 was tested as received, and panel E2 was first impacted in two locations using the described drop tester (see FIG. 12: E1—left side, E2—right side). Two other non-impacted panels (E3 and F1) were scribed with a 1/16″ wide diagonal notch machined across the face through all coatings to the steel substrate (see FIG. 13: E3—left side, F1—right side). One scribed panel E3 was coated with the Formula No. 1 nonskid coating, the other panel F1 had the Formula No. 1 non-skid coating applied on top of a flame sprayed TBC coating. The scribed notches were checked with an ohmmeter for good electrical conductivity along the length of the exposed steel.

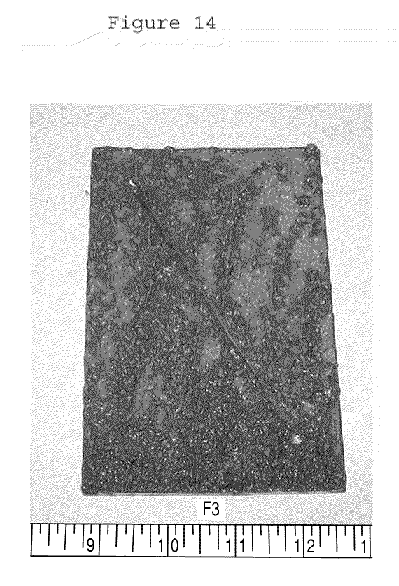

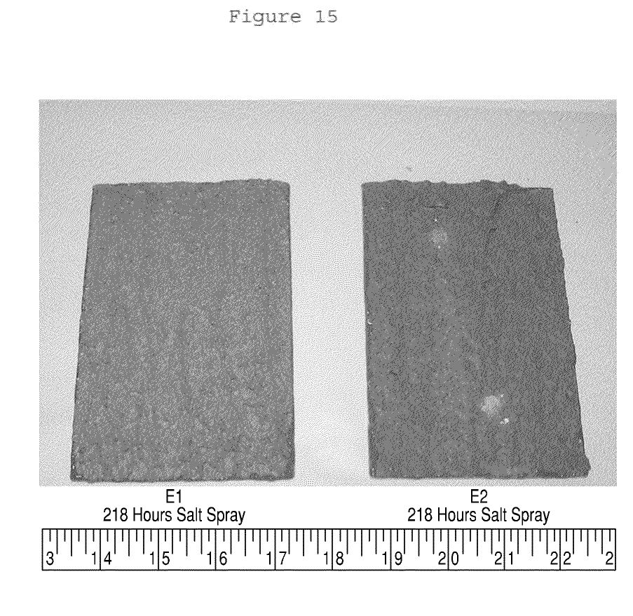

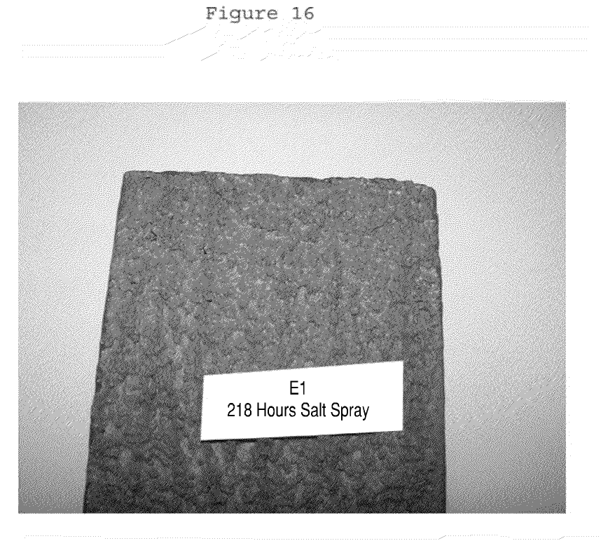

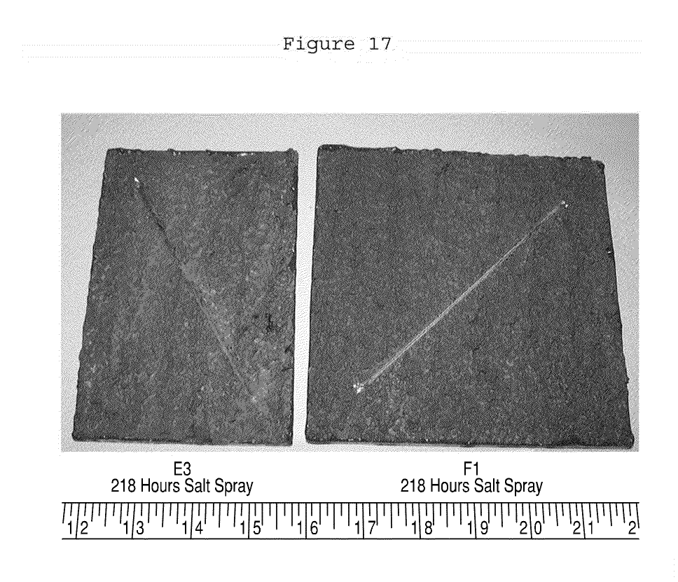

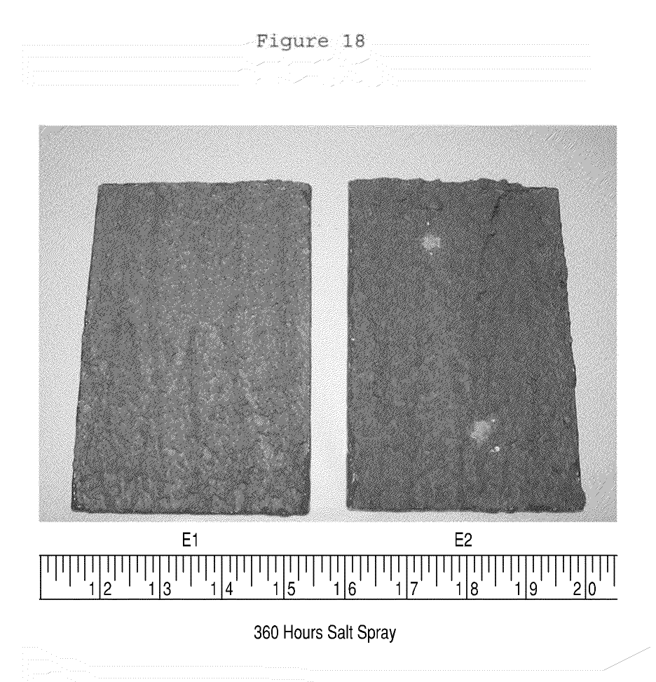

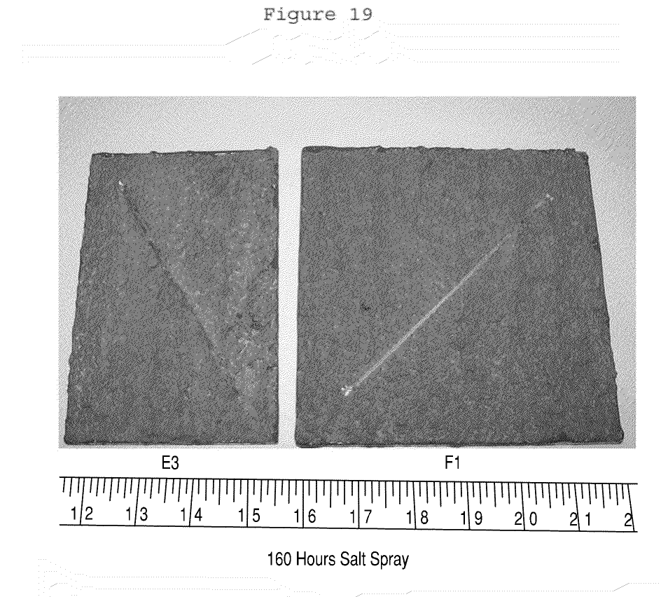

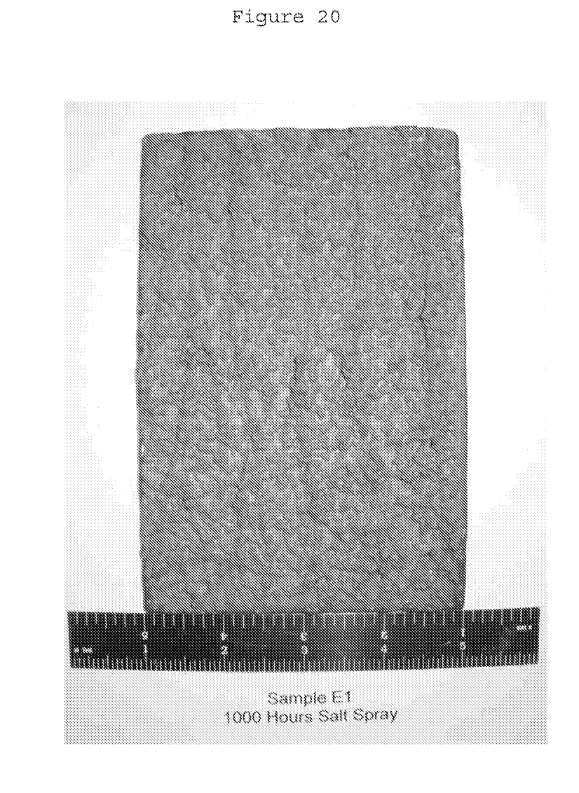

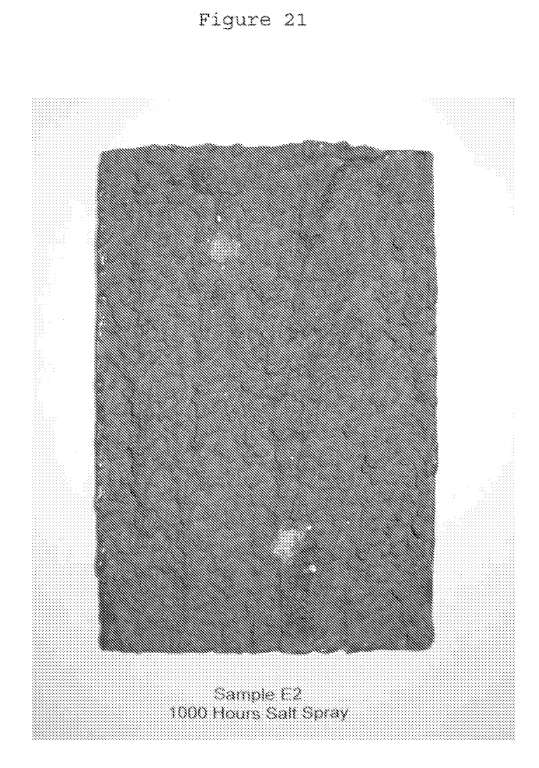

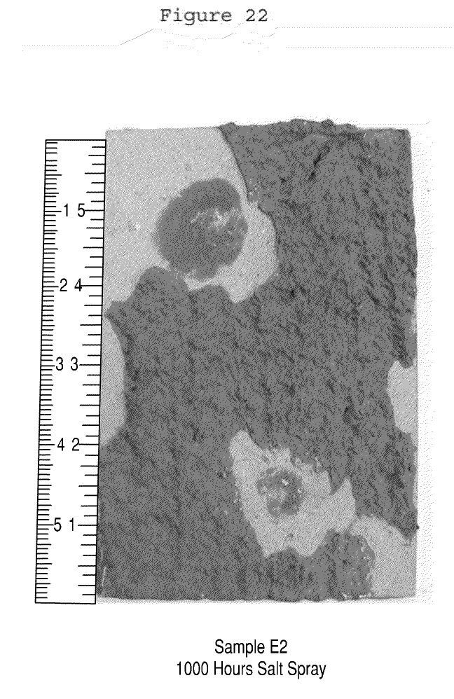

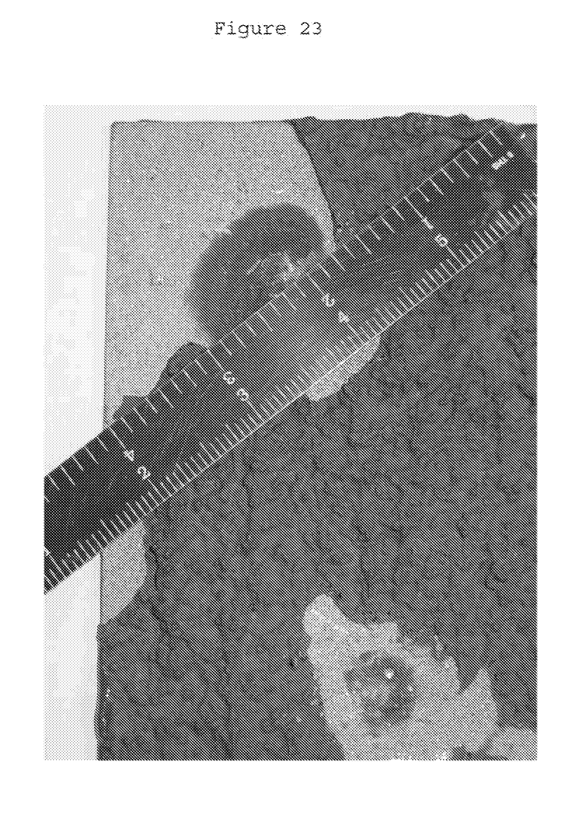

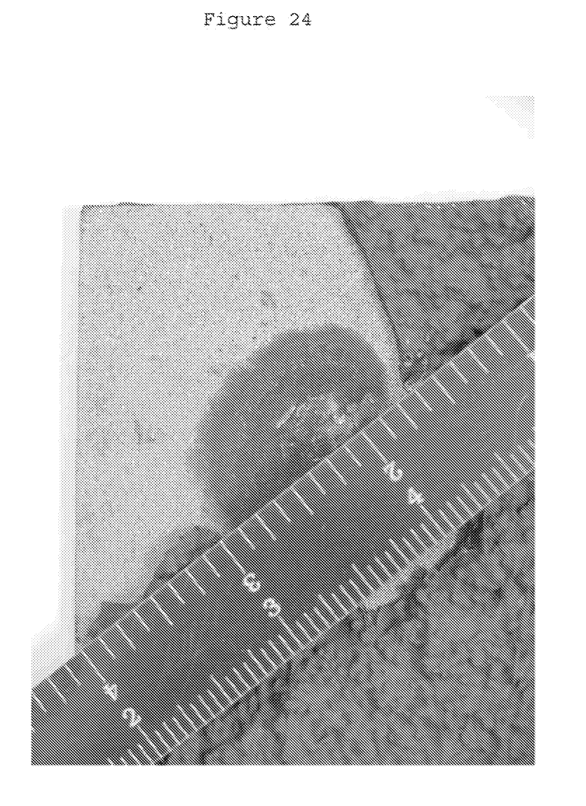

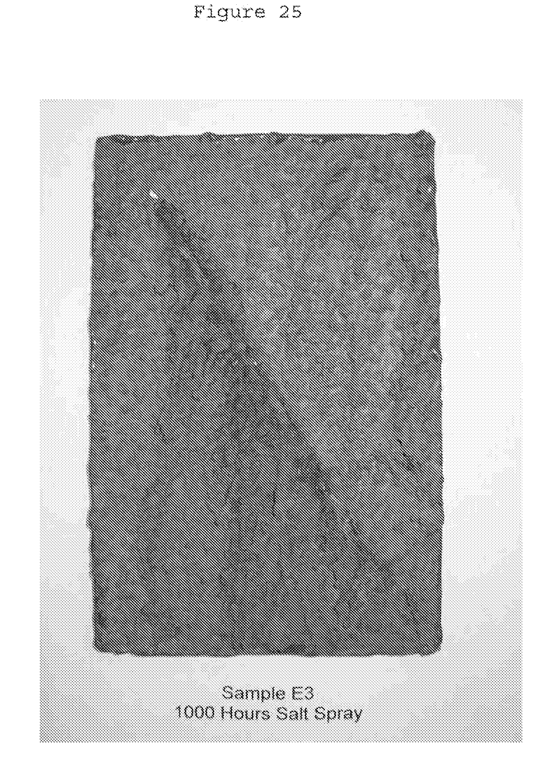

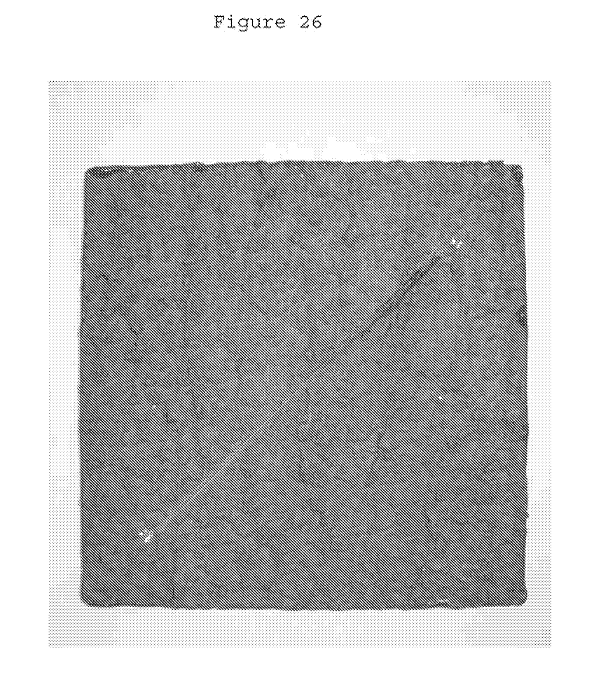

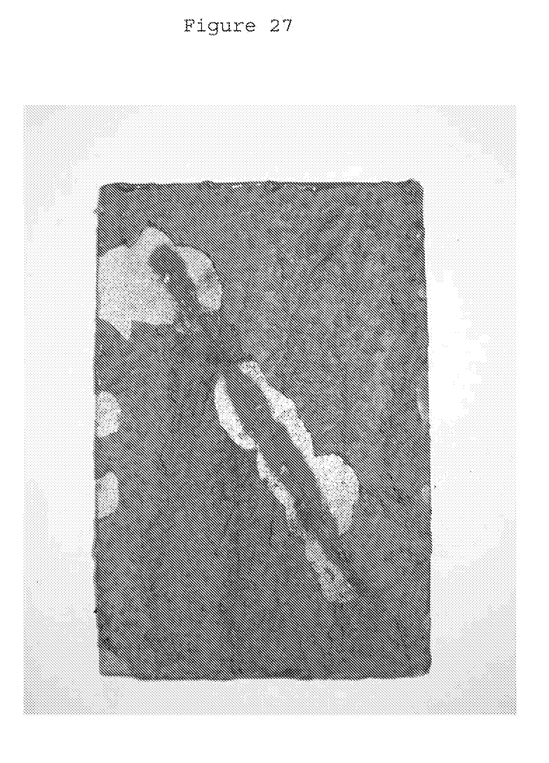

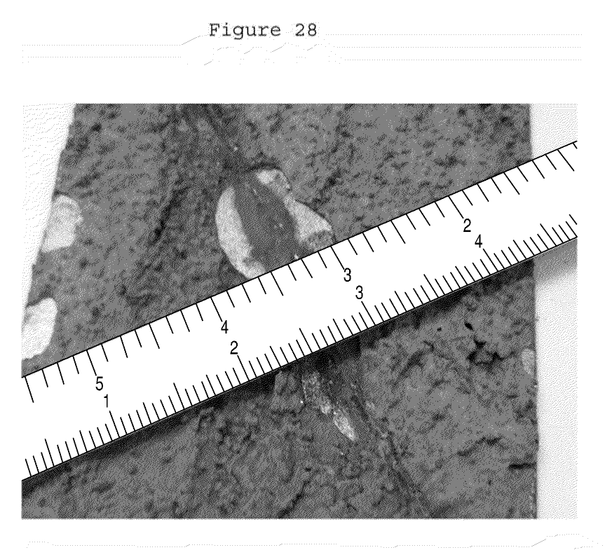

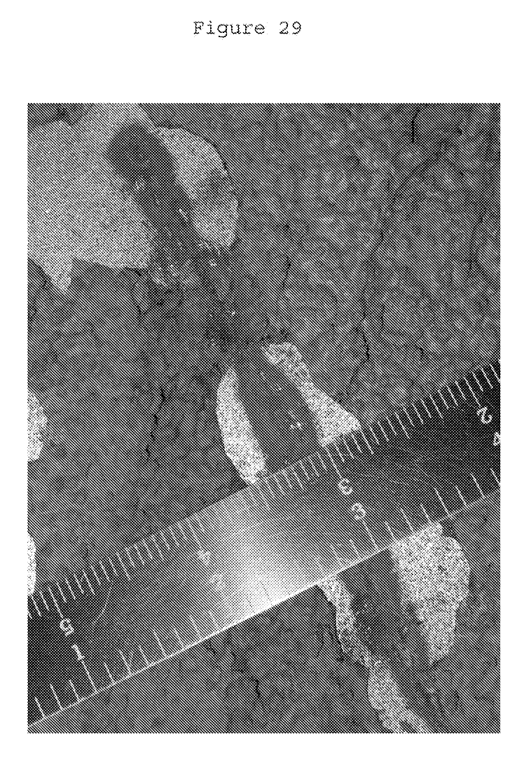

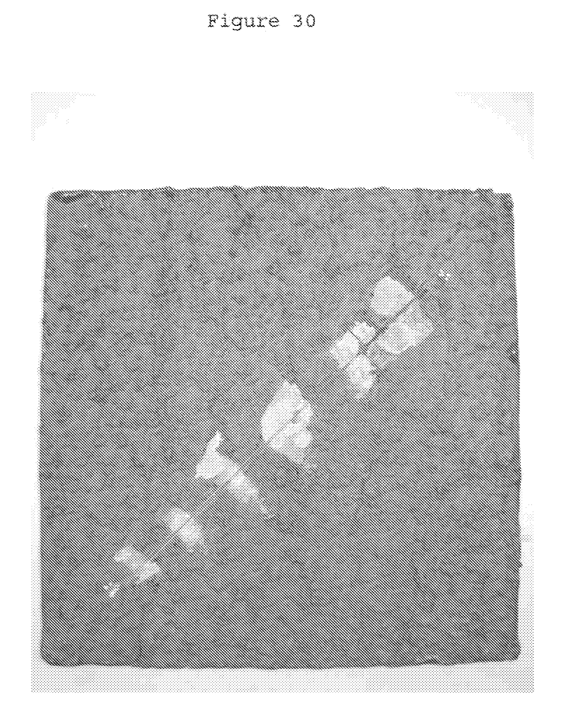

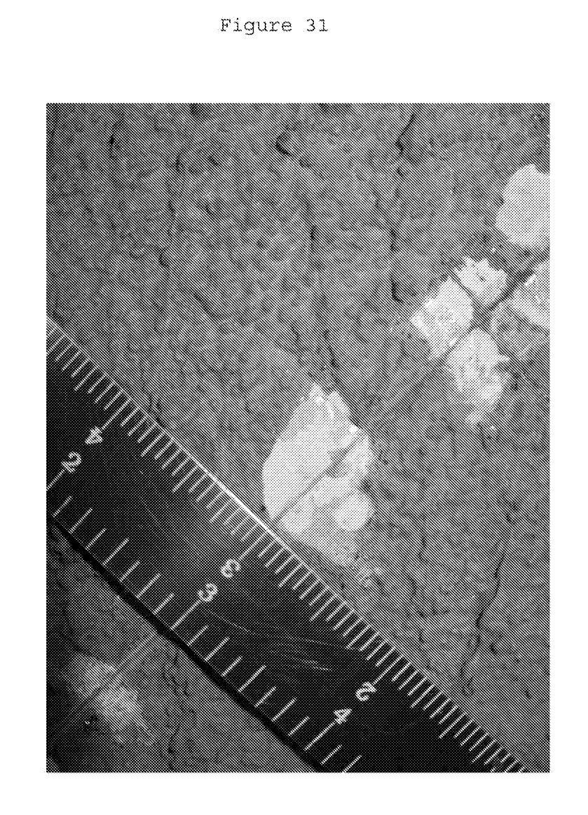

Sample E and F panels were exposed for 1000 hours in a salt-fog cabinet in accordance with ASTM B117 (5% neutral NaCl solution, ASTM B117 incorporated herein by reference). The four salt spray panels prior to testing are shown in FIGS. 12 and 13. Scribed panel E3 shows corrosion after 48 hours salt spray in FIG. 14. Samples E and F after 218 hours salt spray are shown in FIGS. 15-17. Samples E and F after 360 hours salt spray are shown in FIGS. 18 and 19. Samples E1 and E2 after 1000 hours salt spray are shown in FIGS. 20 and 21. The impacted panel E2 was examined by marking the center of impact with a drill and chipping to expose the steel. The examination is illustrated in FIGS. 22-24. The corrosion from the upper left impact had expanded ⅞″ from the center of impact to the left side. The corrosion from the lower right impact had not expanded much beyond the impacted zone. Scribed samples E3 and F1 after 1000 hours salt spray are shown in FIGS. 25 and 26. The scribed panels were probed, but the coatings were very adherent. The coatings were finally removed using a ¼″ wide chisel and hammer. The corrosion on panel E3 had extended from the 1/16″ wide machined scribed line to a maximum width of about ⅜″ under the coating. The results of the examination are shown in FIGS. 27-29. The corrosion on panel F1 had not extended significantly from the 1/16″ wide machined scribed line under the TBC coating. The results of the examination are shown in FIGS. 30 and 31.

Summary for Formula No. 1:

Steel panels with the Formula No. 1 nonskid coating maintained coating integrity and adhesion when tested per MILPRF-24667B.

Panels exposed and aged 10 cycles at 400° F. also performed well when tested per MIL-PRF-24667B.

Panels immersed for 15 days in artificial seawater also performed well when tested per MIL-PRF-24667B.

Panels with a flame sprayed TBC coating under the Formula No. 1 non-skid coating performed no different from the initial exemplary non-skid panels when tested per MIL-PRF-24667B.

Panels exposed for 200 hours UV-B and humidity cycling showed initial rusting under the impact area of the coating. The non-impacted panel did not rust. Removal of the coating showed no corrosion beyond the zone of impact.

Panels exposed to 1000 hours salt spray showed rusting from the 1/16″ wide scribed lines and some minor rusting through the impacted area of the coating. The non-impacted panel did not rust.

The coating was removed from the impacted salt spray panel by chipping. The upper left impact showed the corrosion had increased ⅞ inch from the center of impact to the left side.

The coatings were removed from the scribed salt spray panels along the machined scribes by chipping. The Formula No. 1 epoxy coated panel showed the corrosion width had increased from the 1/16″ scribe to ⅜″ overall, which was not deemed to be significant. The TBC coated panel did not show significant corrosion spreading from the scribe under the coating after 1000 hours salt spray.

### Comparative Example

### Commercial Formula

A commercial non-skid epoxy coating, MS-400G, available from ITW American Safety Technologies of Roseland, N.J., USA, was prepared according to manufacturer's instructions. This commercial non-skid coating is on the “Qualified Purchase List” for the United States military and is representative of the types of non-skid coatings currently in use. The MSDS of MS-400G is hereby incorporated by reference in its entirety. The commercial non-skid coating was evaluated by MIL-PRF-24667B.

Test Panel Preparation—Commercial Epoxy Non-Skid

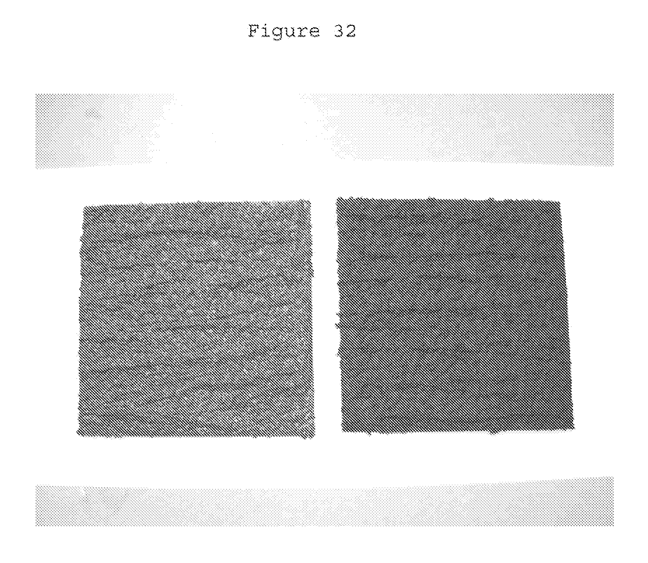

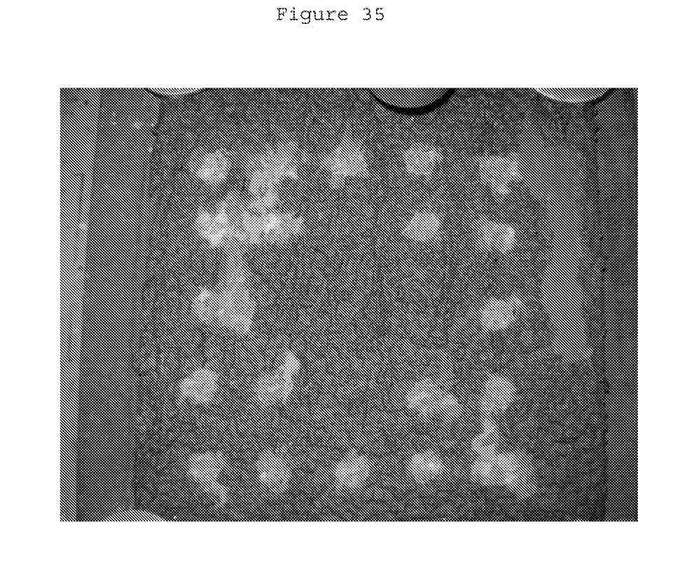

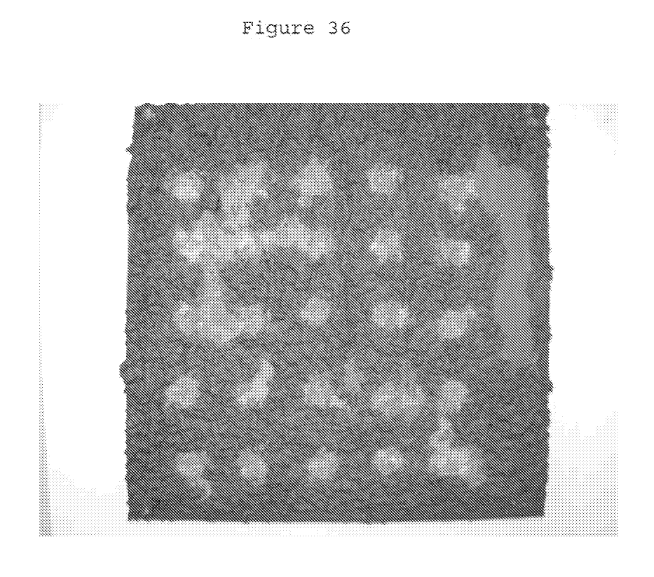

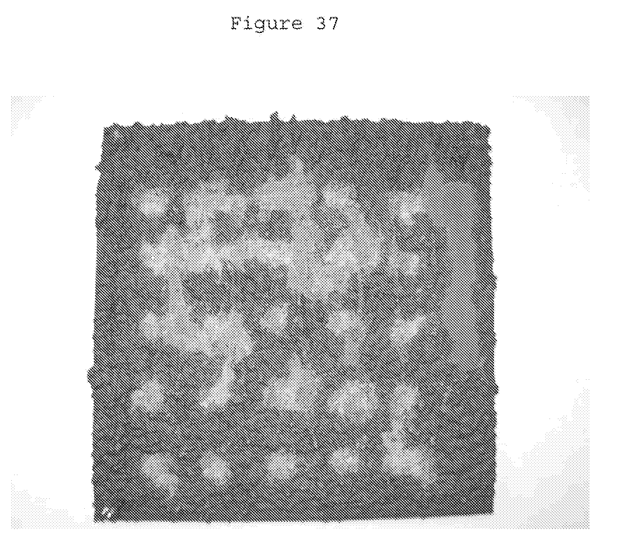

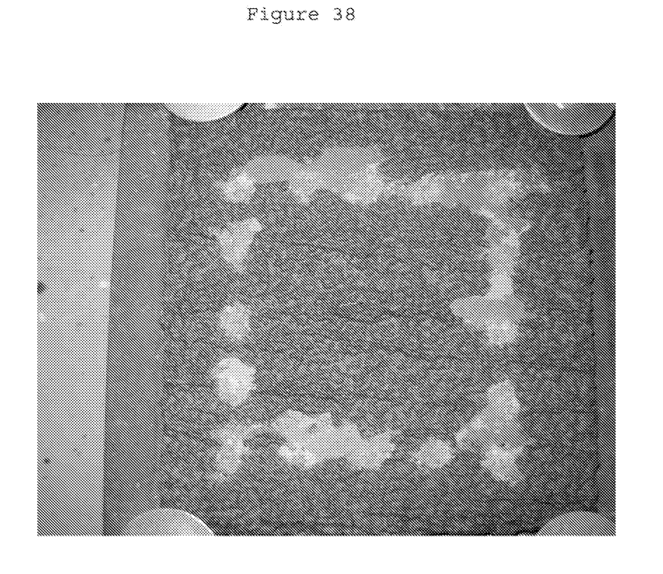

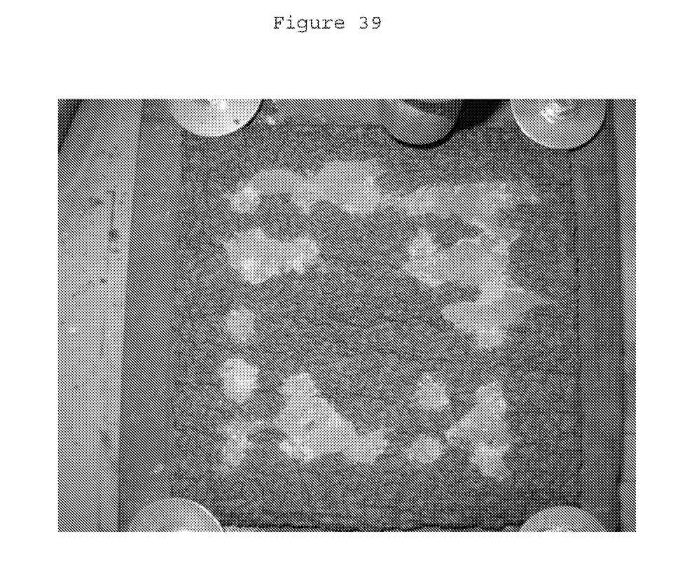

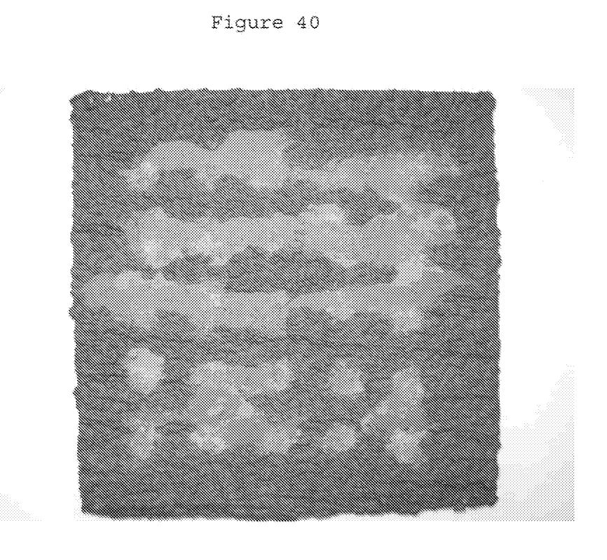

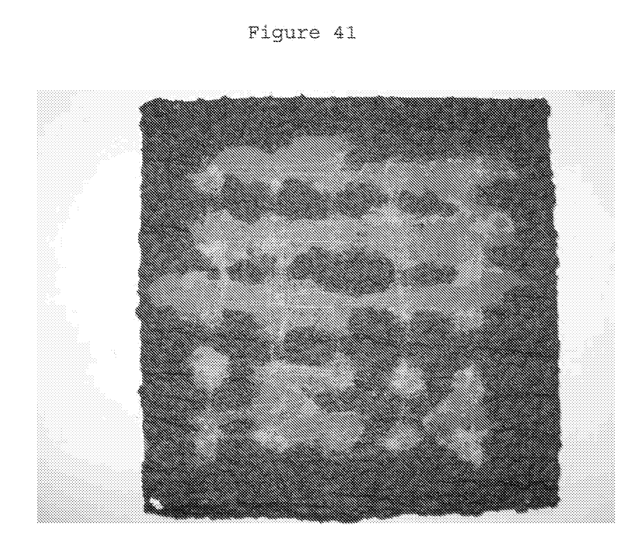

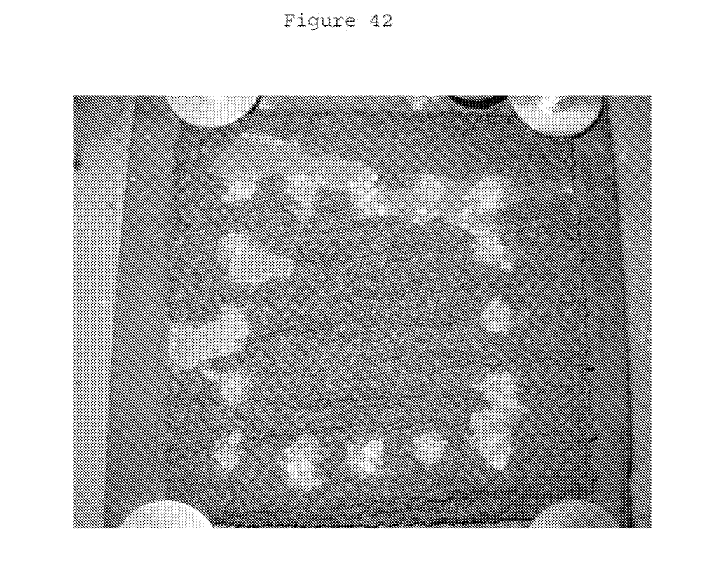

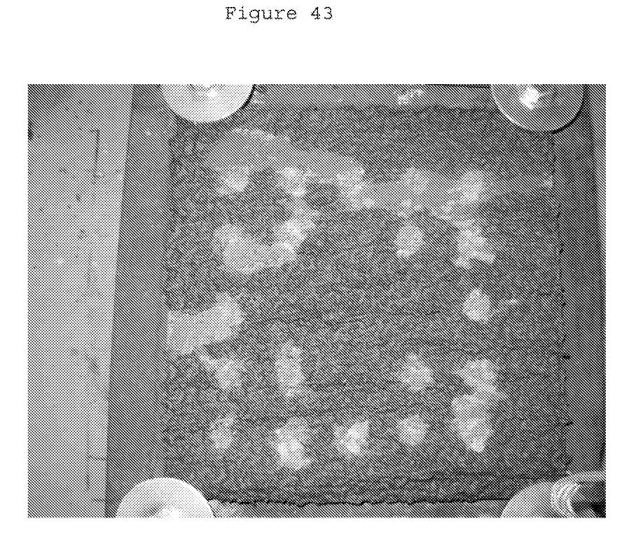

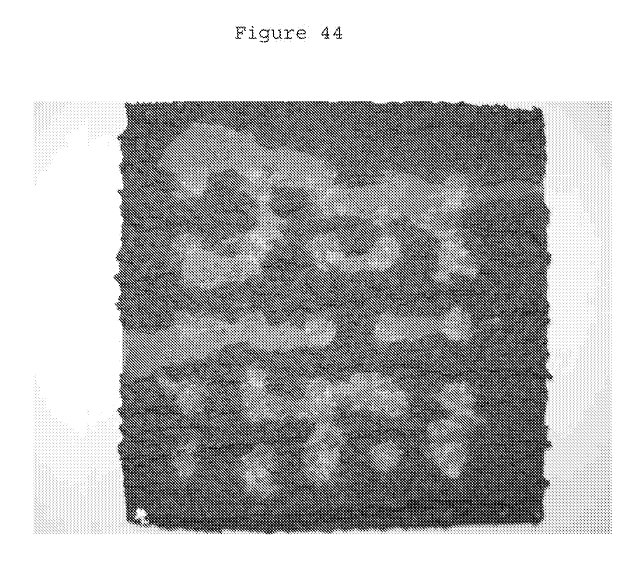

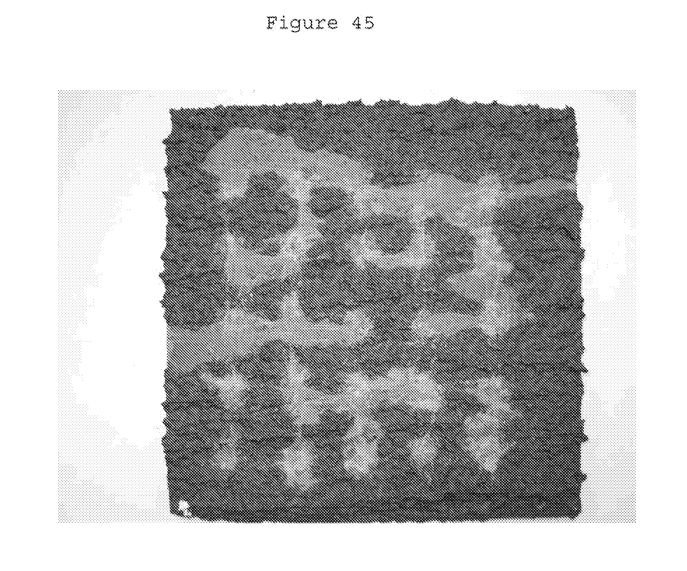

The commercial epoxy non-skid coating was weighed out and mixed. The coating was applied to six steel test panels using a phenolic application roller. The coated panels were allowed to cure and dry at room temperature for 96 hours per the manufacturer's instructions. The six panels are illustrated in FIGS. 32 to 45.

Thermal Aging

After 96 hours three panels with the commercial epoxy non-skid formulation were heat exposed at 400° F. for 10 cycles in an air-circulating oven. The thermal profile was 1 hour ramp-up 80° F.-400° F., 1.5 hours soak at 400° F., 1.5 hours ramp-down, 2 hours stabilize at 80° F. The coatings turned a deep brown. No defects (e.g. blistering or cracks) were noted after heat exposure cycling. FIG. 32 shows two plates with a comparative coating before impact testing (left plate cured at 70° F., right plate thermally aged at 400° F.).

Impact Testing

The six commercially-coated panels were tested in accordance with MIL-PRF-24667B. The drop height was 4 ft. The drop weight was 4.02 lbs and tipped with a ⅝ inch ball striker. The impact sequence was as specified forming a 5×5 test pattern. The impacted plates were probed with a 1 inch cold chisel.

Impact Test Results

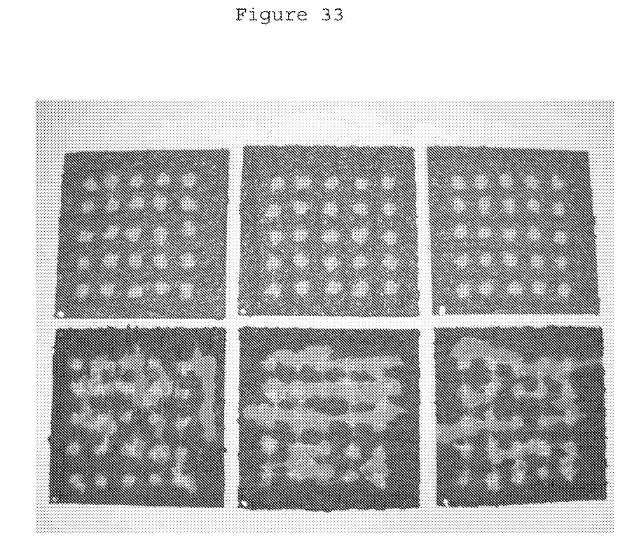

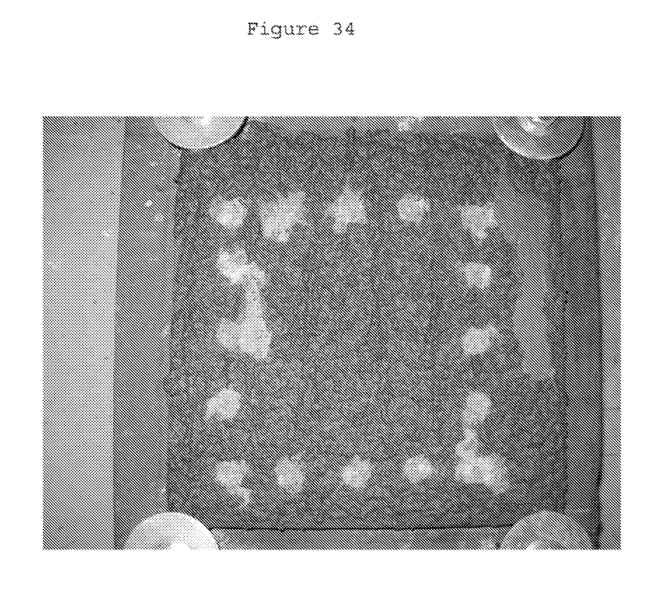

FIG. 33 shows six plates with a comparative coating after impact testing (top row panels 1, 2, and 3 cured at 70° F., bottom row panels 4, 5, and 6 thermally aged at 400° F.)._The results were very different for the two sets of commercially-coated panels. The three room-temperature cured comparative coatings 1, 2, and 3 did not lift and no bridges between impact points were removed with the chisel. The three room-temperature cured comparative panels 1, 2, and 3 passed MIL-PRF-24667B with a rating of 100. However, the three 400° F. thermally-aged comparative coatings 4, 5, and 6 cracked and spalled with successive impacts. Several bridges between impact points were exposed even prior to probing. Probing with the chisel caused additional chipping and lifting of the coatings. Comparative panels 4, 5, and 6 (FIGS. 34-37, 38-41, and 42-45, respectively) had ratings of 72.5, 50 and 57.5 respectively. The three thermally-aged comparative panels 4, 5, and 6 had an average of 60 and were far below the minimum pass criteria of 90.

The three thermally aged panels failed MIL-PRF-24667B.

Summary for Commercial Non-Skid Epoxy:

Steel panels coated with the commercial epoxy non-skid formulation and cured at 70° F. maintained coating integrity and adhesion when tested per MIL-PRF-24667B.

Panels exposed and aged 10 cycles at 400° F. cracked and spalled when tested per MIL-PRF-24667B.

Thermal Conductivity Testing—Exemplary and Comparative

Pairs of 6″×6″×0.25″ thick coated aluminum panels were tested thermal conductivity testing in accordance with ASTM C 1114 (incorporated herein by reference). Panels as tested are listed in Table 1. Samples were coated with the TBC and Formula 1 epoxy described in prior examples.

TABLE 1
Coating Samples:

| | | | Average Coating |
|---|---|---|---|
| Sample ID | Description | Size | Thickness (inch) |
| FS1 | Flame spray TBC + | 6″ × 6″ | 0.0409 |
| | Formula 1 epoxy | | |
| FS2 | Flame spray TBC + | 6″ × 6″ | 0.0536 |
| | Formula 1 epoxy | | |
| NFS3 | Formula 1 epoxy | 6″ × 6″ | 0.0329 |
| NFS4 | Formula 1 | 6″ × 6″ | 0.0217 |
| Z5 | Flame spray TBC | 6″ × 6″ | 0.0198 |
| Z6 | Flame spray TBC | 6″ × 6″ | 0.0211 |

A thin foil heater apparatus was formed by sandwiching two kapton insulated flexible thin foil electric heaters separated by a sheet of compressible Gore-Tex™ between the pairs of coated aluminum test plates with the coating faces facing the heaters. The assemblies were clamped together at the four corners. The edges of the plates were masked with “Class H Insulation” glass cloth electrical tape. The surface temperature of the coatings and the temperature of the back plates were measured via embedded thermocouples and monitored in the steady-state condition using computer data acquisition for 60 minutes. The temperature of the back plates was controlled using a cooling fan. The results are summarized in Table 2.

TABLE 2
Average Thermal Conductivity Results:

| | | Surface | | Thermal | Thermal |
|---|---|---|---|---|---|
| Sample | Heat | Temperature | Delta T | Conductance | Conductivity |
| ID | (Watts) | (° C.) | (° C.) | (Watts/° C.) | (W m/° C. m2 |
| FS1 | 106.6 | 139.5 | 12.59 | 8.48 | 0.211 |
| FS2 | 104.0 | 142.0 | 18.21 | 5.72 | 0.186 |
| Average | | | | 7.10 | 0.199 |
| NFS3 | 104.0 | 144.9 | 12.99 | 8.04 | 0.161 |
| NFS4 | 106.9 | 142.7 | 6.67 | 16.17 | 0.213 |
| Average | | | | 12.11 | 0.187 |
| Z5 | 106.9 | 148.1 | 14.90 | 7.18 | 0.086 |
| Z6 | 104.0 | 143.8 | 10.80 | 9.65 | 0.124 |
| Average | | | | 8.42 | 0.105 |

Summary of Thermal Conductivity Testing:

Aluminum panels coated with the Formula 1 nonskid coating over the flame sprayed TBC coating (FS1 & FS2) had significantly lower thermal conductance compared to the Formula 1 nonskid coating panels (NFS3 and NFS4).

Aluminum panels coated with the Formula 1 nonskid coating over the flame sprayed TBC coating (FS1 & FS2) had lower thermal conductance compared to the flame spray TBC coating panels (Z5 and Z6).

Aluminum panels coated with the Formula 1 nonskid coating over the flame sprayed TBC coating (FS1 & FS2) had similar average thermal conductivity compared to the Formula 1 nonskid coating panels (NFS3 and NFS4).

What is claimed is:

1. A coating composition, comprising:
a novolac epoxy resin comprising silicon carbide powder;
an amine curing agent, said agent comprising at least a cycloaliphatic amine;
a hydrophobic silica thixotrope agent; and
an aluminum oxide powder having the following mesh retention characteristics, based on the weight of the aluminum oxide powder:
about 0 wt. % size 10 mesh,
≧ about 5 wt. % size 16 mesh,
≧ about 20 wt. % size 18 mesh,
≧ about 10 wt. % size 20 mesh, and
≦ about 5 wt. % size 30 mesh.

2. The composition of claim 1, comprising about 30-70 wt. % of the novolac epoxy resin.

3. The composition of claim 1, comprising about 40-60 wt. % of the novolac epoxy resin.

4. The composition of claim 1, comprising about 45-55 wt. % of the novolac epoxy resin.

5. The composition of claim 1, comprising about 1-15 wt. % of the amine curing agent.

6. The composition of claim 1, comprising about 2-10 wt. % of the amine curing agent.

7. The composition of claim 1, comprising about 3-7 wt. % of the amine curing agent.

8. The composition of claim 1, comprising about 0.05-5 wt. % of the hydrophobic silica thixotrope agent.

9. The composition of claim 1, comprising about 0.1-5 wt. % of the hydrophobic silica thixotrope agent.

10. The composition of claim 1, comprising about 0.5-2 wt. % of the hydrophobic silica thixotrope agent.

11. The composition of claim 1, comprising about 20-60 wt. % of the aluminum oxide powder.

12. The composition of claim 1, comprising about 25-55 wt. % of the aluminum oxide powder.

13. The composition of claim 1, comprising about 30-50 wt. % of the aluminum oxide powder.

14. The composition of claim 1, comprising about:
30-70 wt. % of the novolac epoxy resin;
1-15 wt. % of the amine curing agent;
0.05-5 wt. % of the hydrophobic silica thixotrope; and
20-60 wt. % of the aluminum oxide powder.

15. A non-skid coating, comprising the cured product of the composition of claim 1.

16. A method of coating a surface, comprising applying the composition of claim 1 to the surface and allowing to cure.

17. A surface, comprising the non-skid coating of claim 15 thereon.

18. The surface of claim 17, further comprising a primer coat between the coating and the surface.

19. A kit for coating, comprising:
(a) a resin package, comprising:
a novolac epoxy resin comprising silicon carbide powder;
a hydrophobic silica thixotrope agent;
an aluminum oxide powder having the following mesh retention characteristics, based on the weight of the aluminum oxide powder:
about 0 wt. % size 10 mesh,
≧ about 5 wt. % size 16 mesh,
≧ about 20 wt. % size 18 mesh,
≧ about 10 wt. % size 20 mesh, and
≦ about 5 wt. % size 30 mesh; and
(b) a curing agent package, comprising:
an amine curing agent, said curing agent comprising at least a cycloaliphatic amine.

20. A method of coating a surface, comprising:
contacting the contents of the resin package (a) of claim 19 with the contents of the curing agent package (b) of claim 19, mixing, and applying to a surface.

21. A non-skid coating, comprising:
a thermal barrier coat comprising a metallic bond coat and a yttria-stabilized topcoat in contact with the metallic bond coat; and
a non-skid epoxy coat in contact with the yttria-stabilized topcoat.
